(19) United States
(12) Patent Application Publication
(10) Pub. No.: US 2026/0022198 A1
(43) Pub. Date: Jan. 22, 2026

(54) SOLID CATALYST COMPONENT MIXTURE FOR POLYMERIZING OLEFINS, CATALYST FOR POLYMERIZING OLEFINS, AND PRODUCTION METHOD OF POLYMER OF OLEFINS

(71) Applicant: TOHO TITANIUM CO., LTD., Chigasaki-shi, Kanagawa (JP)

(72) Inventors: Hayashi Ogawa, Chigasaki-shi, Kanagawa (JP); Keiichi Kurosaki, Chigasaki-shi, Kanagawa (JP); Hideo Funabashi, Chigasaki-shi, Kanagawa (JP)

(73) Assignee: TOHO TITANIUM CO., LTD., Chigasaki-shi, Kanagawa (JP)

(21) Appl. No.: 18/998,745

(22) PCT Filed: Jul. 27, 2023
(86) PCT No.: PCT/JP2023/027513

§ 371 Date: Jan. 27, 2025

(30) Foreign Application Priority Data
Jul. 28, 2022 (JP) 2022-120447

(51) Int. Cl. C08F 4/642; C08F 110/00

(52) U.S. Cl. CPC C08F 4/6423; C08F 110/00

(57) ABSTRACT

A solid catalyst component mixture for polymerizing olefins that allows a polymer of olefins having both a high melt flowability and rigidity to be easily produced is provided.

A solid catalyst component mixture for polymerizing olefins comprises: a first solid catalyst component for polymerizing olefins containing magnesium, titanium, halogen and a succinate diester compound, and a second solid catalyst component for polymerizing olefins containing magnesium, titanium, halogen and a phthalate diester compound, at a mass ratio of First solid catalyst component for polymerizing olefins:Second solid catalyst component for polymerizing olefins=37:63 to 87:13.

### TECHNICAL FIELD

The present invention relates to a solid catalyst component mixture for polymerizing olefins, a catalyst for polymerizing olens, and a production method of a polymer of olefins.

### BACKGROUND ART

In recent years, a polymer of olefins such as polypropylene (SP) have been used in various applications such as containers and films, as well as molded products such as automobile parts and home appliances.

Polypropylene-based resin compositions are lightweight and excellent in moldability, and a molding thereof has excellent heat resistance and chemical stability such as resistance to chemicals, with excellent cost performance, being used in many fields as one of the most important plastic materials.

In order to expand further applications, polypropylenes having excellent moldability with high melt flowability (melt flow rate (MFR)), and excellent flexural modulus (FM) have been desired for use as a substitute for polystyrene and ABS resins.

In the polymerization of olefins such as propylene, a polymerization method using a solid catalyst component containing magnesium atoms, titanium atoms, halogen atoms, and an internal electron-donating compound as essential components is known. Many methods have been proposed for polymerizing or copolymerizing olefins in the presence of the solid catalyst component and catalyst for polymerizing olefins formed of an organic aluminum compound and an organic silicon compound (refer to Patent Literature 1, etc.).

For example, in Patent Literature 1, proposed is a method for polymerizing propylene by using a catalyst for polymerizing olefins containing solid titanium catalyst components on which an internal electron-donating compound such as phthalate ester is supported, and an organic aluminum compound and an organic silicon compound having at least one Si—O—C bond as cocatalyst components. In various literature including Patent Literature 1, a method for producing highly stereoregular polymers under high polymerization activity using a phthalate ester as internal electron-donating compound is proposed.

### CITATION LIST

### Patent Literature

### Patent Literature 1

Japanese Patent Laid-Open No. 57-63310

### Patent Literature 2

Japanese Patent Laid-Open No. 2000-017019

### SUMMARY OF THE INVENTION

### Technical Problem

However, in recent years, a solid catalyst component for polymerizing olefins, which allows a polypropylene having a more excellent flexural modulus (FM) than the case of using a solid catalyst component including a phthalate ester as internal electron-donating compound, more specifically a polypropylene having a high flexural modulus (FM) of 1900 MPa or more, to be produced, have been required.

Through extensive study to solve the technical problem, the present inventors have found that by using a solid catalyst component for polymerizing olefins containing a succinate diester compound as internal electron-donating compound, a polypropylene with excellent rigidity, having a flexural modulus (FM) of 1900 MPa or more can be produced.

On the other hand, as described above, a solid catalyst component for polymerizing olefins, with which a polymer of olefins having excellent rigidity with a high flexural modulus (FM) and excellent moldability with a high melt flowability (melt flow rate (MFR)) can be produced, has been required.

However, in a polymer of olefins produced using a catalyst for polymerizing olefins (including a solid catalyst component for polymerizing olefins), the melt flowability (melt flow rate (MFR)) and flexural modulus (FM) are generally in a tradeoff relationship.

Even in the case of producing a polypropylene having a flexural modulus (FM) of 1900 MPa or more using a solid catalyst component for polymerizing olefins containing a succinate diester compound as internal electron-donating compound, the resulting polypropylene tends to have an extremely reduced melt flowability (melt flow rate (MFR)).

A conceivable method for producing a polymer of olefins having both a high flexural modulus (FM) and a high melt flowability (melt flow rate (MFR)) includes mixing a plurality types of polymers of olefins, that is, producing a polymer of olefins having a high melt flowability and a polymer of olefins having a high flexural modulus separately and then mixing the polymers.

However, in the case of mixing a plurality types of olefin polymers, polymers with greatly different physical properties tend to be hardly mixed with each other. Depending on the olefin polymers to be mixed, a special mixing device excellent in stirring force during mixing and a large amount of energy cost may be required with an increased number of steps. Thus, there is a technical problem that a polymer of olefins having desired properties is hardly produced.

A solid catalyst component for polymerizing olefins, with which a polymer of olefins having excellent moldability having a high melt flowability (melt flow rate (MFR)) of 80 to 120 g/10 minutes and excellent rigidity with a high flexural modulus (FM) of 1900 MPa or more can be produced, has not been known yet.

Under these circumstances, the present invention aims to provide a technical means that allows a polymer of olefins having both a high melt flowability and rigidity to be easily produced.

### Solution to Problem

Through extensive studies to solve the technical problem, the present inventors have found that the problem can be solved by using a solid catalyst component mixture for polymerizing olefins obtained by mixing a first solid catalyst component for polymerizing olefins containing magnesium, titanium, halogen and a succinate diester compound and a second solid catalyst component for polymerizing olefins containing magnesium, titanium, halogen and a phthalate diester compound at a predetermined ratio, so that the present invention has been completed based on the founding.

Accordingly, the present invention provides the following:
(i) A solid catalyst component mixture for polymerizing olefins comprising:
   a first solid catalyst component for polymerizing olefins containing magnesium, titanium, halogen and a succinate diester compound and
   a second solid catalyst component for polymerizing olefins containing magnesium, titanium, halogen and a phthalate diester compound
   at a mass ratio of First solid catalyst component for polymerizing olefins:Second solid catalyst component for polymerizing olefins=37:63 to 87:13.
(ii) The solid catalyst component mixture for polymerizing olefins according to the item (i), wherein the content ratio of the succinate diester compound in terms of solid content is 4.7 to 14.9 mass %.
(iii) The solid catalyst component mixture for polymerizing olefins according to the item (i) or (i), wherein the content ratio of the phthalate diester compound in terms of solid content is 2.2 to 7.9 mass %.
(iv) A catalyst for polymerizing olefins comprising:
   (I) the solid catalyst component mixture for polymerizing olefins according to any one of the items (i) to (iii) and
   (II) one or more organic aluminum compounds selected from the compounds represented by the following general formula (1):

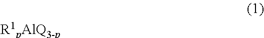

wherein R¹ is an alkyl group having 1 to 6 carbon atoms, Q is a hydrogen atom or a halogen atom, p satisfies 0<p≤3, and when a plurality of R¹ is present, R¹ may be the same or different from each other, and when a plurality of Q is present, Q may be the same or different from each other.
(v) A catalyst for polymerizing olefins according to the items (iv) comprising:
   (I) the solid catalyst component mixture for polymerizing olefins according to any one of the items (i) to (iii),
   (II) one or more organic aluminum compounds selected from the compounds represented by the following general formula (1):

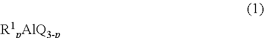

wherein R¹ is an alkyl group having 1 to 6 carbon atoms, Q is a hydrogen atom or a halogen atom, p satisfies 0<p≤3, and when a plurality of R¹ is present, R¹ may be the same or different from each other, and when a plurality of Q is present, Q may be the same or different from each other, and
(III) an external electron-donating compound.
(vi) A method for producing polymer of olefins comprising polymerizing olefins using the catalyst for polymerizing olefins according to the items (iv) or (v).

### Advantageous Effects of Invention

According to the present invention, a solid catalyst component mixture for polymerizing olefins that allows a polymer of olefins having both a high melt flowability and rigidity to be easily produced is provided together with production methods of a catalyst for polymerizing olefins and a polymer of olefins.

### BRIEF DESCRIPTION OF DRAWINGS

FIG. 1 is an illustration of the preparation method of a measurement sample for measuring the ratio of oriented layer in a cross-section of an injection molded plate of a polymer of olefins.

FIG. 2 is an illustration of the preparation method of a measurement sample for measuring the ratio of oriented layer in a cross-section of an injection molded plate of a polymer of olefins.

FIG. 3 is a chart illustrating a method for determining the ratio of an oriented layer.

FIG. 4 is a polarizing microscope image of the measurement sample prepared for measurement of the ratio of oriented layer in the cross-section of an injection molded plate of a polymer of olefins.

FIG. 5 is a polarizing microscope image of the measurement sample prepared for measurement of the ratio of oriented layer in the cross-section of an injection molded plate of a polymer of olefins.

FIG. 6 is a polarizing microscope image of the measurement sample prepared for measurement of the ratio of oriented layer in the cross-section of an injection molded plate of a polymer of olefins.

FIG. 7 is a polarizing microscope image of the measurement sample prepared for measurement of the ratio of oriented layer in the cross-section of an injection molded plate of a polymer of olefins.

FIG. 8 is a polarizing microscope image of the measurement sample prepared for measurement of the ratio of oriented layer in the cross-section of an injection molded plate of a polymer of olefins.

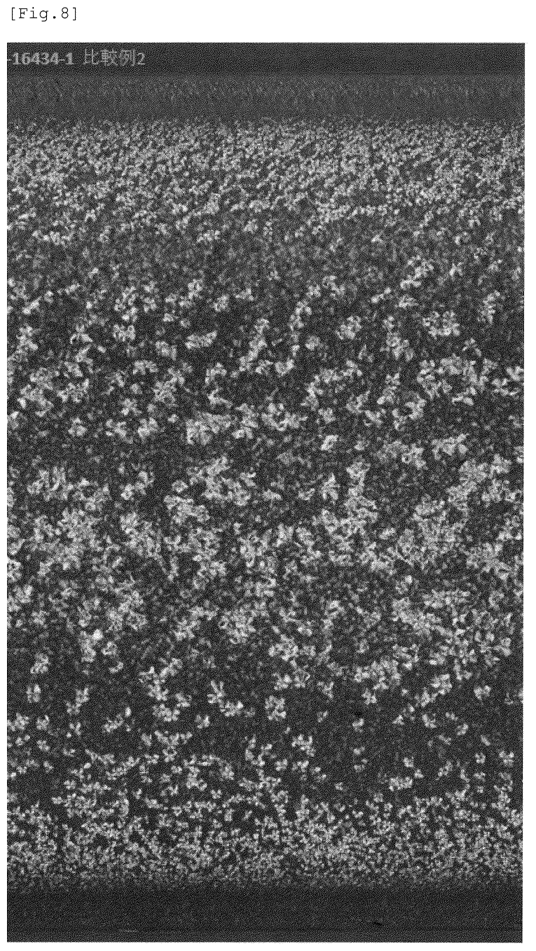

FIG. 9 is a polarizing microscope image of the measurement sample prepared for measurement of the ratio of oriented layer in the cross-section of an injection molded plate of a polymer of olefins.

FIG. 10 is a polarizing microscope image of the measurement sample prepared for measurement of the ratio of oriented layer in the cross-section of an injection molded plate of a polymer of olefins.

### DESCRIPTION OF EMBODIMENTS

First, a solid catalyst component mixture for polymerizing olefins according to the present invention is described.

The solid catalyst component mixture for polymerizing olefins according to the present invention comprises:
a first solid catalyst component for polymerizing olefins containing magnesium, titanium, halogen and a succinate diester compound and
a second solid catalyst component for polymerizing olefins containing magnesium, titanium, halogen and a phthalate diester compound
at a mass ratio of First solid catalyst component for polymerizing olefins:Second solid catalyst component for polymerizing olefins=37:63 to 87:13.

The solid catalyst component mixture for polymerizing olefins according to the present invention includes a first solid catalyst component for polymerizing olefins.

Examples of the first solid catalyst component for polymerizing olefins constituting the solid catalyst component mixture for polymerizing olefins according to the present invention include a contact reaction product obtained by contacting and reacting raw material components serving as a supply source of magnesium, titanium and halogen and a succinate diester compound as an internal electron-donating compound with each other in an organic solvent. Specific examples of the contact reaction product include one obtained by using a magnesium compound and a tetravalent titanium halogen compound as raw material components to supply source of magnesium, titanium and a halogen, and contacting these raw materials and a succinate diester compound as an internal electron-donating compound with each other.

Examples of the magnesium compound include one or more selected from dialkoxy magnesium, magnesium dihalide, alkoxy magnesium halide, etc.

Among the magnesium compounds, dialkoxy magnesium or magnesium dihalide is preferred, and specific examples thereof include dimethoxy magnesium, diethoxy magnesium, dipropoxy magnesium, dibutoxy magnesium, ethoxy methoxy magnesium, ethoxy propoxy magnesium, butoxy ethoxy magnesium, magnesium dichloride, magnesium dibromide and magnesium diiodide. In particular, diethoxy magnesium and magnesium dichloride are preferred.

Among the magnesium compounds, dialkoxy magnesium may be obtained by reacting metallic magnesium with alcohol in the presence of a halogen or a halogen-containing metal compound.

The dialkoxy magnesium is preferably in a granular or powdery form, and the shape thereof may be amorphous or spherical.

With use of a spherical dialkoxy magnesium, a polymer powder having a better (more spherical) particle shape and narrow particle size distribution is obtained, so that the handling of the polymer powder produced during polymerization operation is improved and occurrence of clogging or the like caused by fine powder contained in the produced polymer powder can be suppressed.

The spherical dialkoxy magnesium may not necessarily be truly spherical, and ones in an elliptical or potato shape may also be used.

Further, the average particle diameter (average particle diameter D50) of the dialkoxy magnesium is preferably 1.0 to 200.0 μm, more preferably 5.0 to 150.0 μm. Here, the average particle diameter D50 means the particle diameter at a cumulative particle size of 50% in the volume cumulative particle size distribution measured using a laser light scattering diffraction particle size analyzer.

In the case of spherical dialkoxy magnesium, the average particle diameter D50 is preferably 1.0 to 100.0 μm, more preferably 5.0 to 80.0 μm, and still more preferably 10.0 to 70.0 μm.

Further, regarding the particle size distribution of the dialkoxy magnesium, a narrow particle size distribution with few fine particles and coarse particles is preferred.

Specifically, in the dialkoxy magnesium measured using a laser light scattering diffraction particle size analyzer, the proportion of particles with a particle diameter of 5.0 μm or less is preferably 20% or less, more preferably 10% or less. On the other hand, in the dialkoxy magnesium measured using a laser light scattering diffraction particle size analyzer, the proportion of particles with a particle diameter of 100.0 μm or more is preferably 20% or less, more preferably 10% or less.

Furthermore, the particle size distribution expressed as ln(D90/D1G) is preferably 3 or less, more preferably 2 or less. Here, the average particle diameter 090 means the particle diameter at a cumulative particle size of 901 in the volume cumulative particle size distribution measured using a laser light scattering diffraction particle size analyzer. Moreover, the average particle diameter D10 means the particle diameter at a cumulative particle size of 10V in the volume cumulative particle size distribution measured using a laser light scattering diffraction particle size analyzer.

The method for producing the spherical dialkoxy magnesium may be referred to, for example, Japanese Patent Laid-Open No. 62-51633, Japanese Patent Laid-Open No. 3-74341, Japanese Patent Laid-Open No. 4-368391, and Japanese Patent Laid-Open No. 8-73388.

In the solid catalyst component for polymerizing olefins according to the present invention, the magnesium compound has a specific surface area of preferably 5 m²/g or more, more preferably 5 to 50 m²/g, and still more preferably 10 to 40 m²/g.

With use of the magnesium compound having a specific surface area in the range, a solid catalyst component for polymerizing olefins having a desired specific surface area can be easily prepared.

In the present application document, the specific surface area of the magnesium compound means a value measured by the BET method. Specifically, the specific surface area of the magnesium compound means a value measured by the BET method (automatic measurement), in which a measurement sample is vacuum dried at 50° C. for 2 hours in advance and then measured by an Automatic Surface Area Analyzer HM model-1230 manufactured by Mountech in the presence of a mixed gas of nitrogen and helium.

The magnesium compound is preferably in a solution or suspension form during the reaction. The solution or suspension form allows the reaction to proceed suitably.

In the case where the magnesium compound is a solid, the magnesium compound in a solution form may be prepared by dissolving the solid in a solvent capable of solubilizing the magnesium compound, or a magnesium compound suspension may be prepared by suspending the solid in a solvent incapable of solubilizing the magnesium compound.

In the case where the magnesium compound is a liquid, the liquid may be directly used as a magnesium compound in a solution form, or may be further dissolved in a solvent capable of solubilizing the magnesium compound for use as the magnesium compound in a solution form.

Examples of the compound capable of solubilizing a solid magnesium compound include at least one compound selected from the group consisting of alcohols, ethers and esters. Alcohols such as ethanol, propanol, butanol and 2-ethylhexanol are preferred, and 2-ethylhexanol is particularly preferred.

On the other hand, examples of the medium incapable of solubilizing magnesium compounds in a solid form include one or more selected from saturated hydrocarbon solvents and unsaturated hydrocarbon solvents that do not dissolve magnesium compounds.

In the solid catalyst component for polymerizing olefins constituting the catalyst for polymerizing olefins according to the present invention, the tetravalent titanium halogen compound which is a raw material component as a supply source of titanium and halogen is not particularly limited, and preferably one or more compounds selected from the group of titanium halides or alkoxy titanium halides represented by the following general formula (2):

Ti(OR²)ᵣX₆₋ᵣ (2)
wherein R² represents an alkyl group having 1 to 4 carbon atoms, X represents a halogen atom such as a chlorine atom, a bromine atom and an iodine atom, and r satisfies 0≤r≤3.

In the general formula (2), r satisfies 0≤r≤3, and specific examples of r include 0, 1, 2 and 3.

Examples of the titanium halide represented by the general formula (2) include one or more titanium tetrahalides selected from titanium tetrachloride, titanium tetrabromide, titanium tetraiodide, etc.

Further, examples of the alkoxy titanium halide represented by the general formula (2) include one or more selected from methoxy titanium trichloride, ethoxy titanium trichloride, propoxy titanium trichloride, n-butoxy titanium trichloride, dimethoxy titanium dichloride, diethoxy titanium dichloride, dipropoxy titanium dichloride, di-n-butoxy titanium dichloride, tri methoxy titanium chloride, triethoxy titanium chloride, tripropoxy titanium chloride, tri-n-butoxy titanium chloride, etc.

As the tetravalent titanium halogen compound, titanium tetrahalide is preferred, and titanium tetrachloride is more preferred.

These titanium compounds may be used alone or in combination of two or more.

In the first solid catalyst component for polymerizing olefins constituting the solid catalyst mixture for polymerizing olefins according to the present invention, examples of the succinate diester compound include one or more selected from the compounds represented by the following general formula (3):

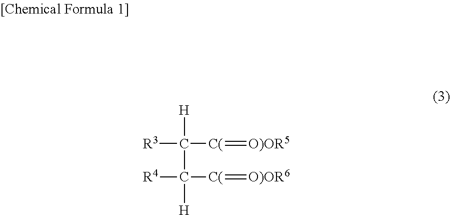

wherein R³ and R⁴ are a hydrogen atom or an alkyl group having 1 to 4 carbon atoms, which may be the same or different from each other, and R⁵ and R⁶ are a straight-chain alkyl group or branched alkyl group having 2 to 4 carbon atoms, which may be the same or different from each other.

In the compound represented by the general formula (3), R³ and R⁴ are a hydrogen atom or an alkyl group having 1 to 4 carbon atoms, and may be the same or different from each other.

In the case where R³ or R⁴ is an alkyl group having 1 to 4 carbon atoms, specific examples thereof include a methyl group, an ethyl group, an n-propyl group, an isopropyl group, an n-butyl group, and an isobutyl group.

In the compound represented by the general formula (3), R⁵ and R⁶ are a straight-chain alkyl group or branched alkyl group having 2 to 4 carbon atoms, and may be the same or different from each other.

In the case where R⁵ and R⁶ are a straight-chain alkyl group or branched alkyl group having 2 to 4 carbon atoms, specific examples thereof include an ethyl group, an n-propyl group, an isopropyl group, an n-butyl group, and an isobutyl group.

In the first solid catalyst component for polymerizing olefins constituting the solid catalyst component mixture for polymerizing olefins according to the present invention, examples of the dialkyl succinate ester compound represented by the general formula (3) as succinate diester compound include one or more selected from:
diethyl succinate, diethyl 2,3-dimethyl succinate, diethyl 2,3-diethyl succinate, diethyl 2,3-di-n-propyl succinate, diethyl 2,3-diisopropyl succinate, 2,3-di-diethyl n-buty succinate, diethyl 2,3-diisobutyl succinate;
di-n-propyl succinate, di-n-propyl 2,3-dimethyl succinate, di-n-propyl 2,3-diethyl succinate, di-n-propyl 2,3-di-n-propyl succinate, di-n-propyl 2,3-diisopropyl succinate, di-n-propyl 2,3-di-n-butyl succinate, di-n-propyl 2,3-diisobutyl succinate;
diisopropyl succinate, diisopropyl 2,3-dimethyl succinate, diisopropyl 2,3-diethyl succinate, diisopropyl 2,3-di-n-propyl succinate, diisopropyl 2,3-diisopropyl succinate, 2,3-di-diisopropyl n-butyl succinate, diisopropyl 2,3-diisobutyl succinate;
di-n-butyl succinate, di-n-butyl 2,3-dimethyl succinate, di-n-butyl 2,3-diethyl succinate, di-n-butyl 2,3-di-n-propyl succinate, di-n-butyl 2,3-diisopropyl succinate, di-n-butyl 2,3-di-n-butyl succinate, di-n-butyl, 2,3-diisobutyl succinate;
diisobutyl succinate, diisobutyl 2,3-dimethyl succinate, diisobutyl 2,3-diethyl succinate, diisobutyl 2,3-di-n-propyl succinate, diisobutyl 2,3-diisopropyl succinate, 2,3-di-diisobutyl n-butyl succinate, and diisobutyl 2,3-diisobutyl succinate.

Among these dialkyl succinate esters, diethyl succinate, di-n-propyl succinate, di-n-butyl succinate, diisobutyl succinate, 2,3-di-n-propyl diethyl succinate, 2,3-di-n-propyl succinate, diethyl diisopropyl succinate, di-n-propyl 2,3-di-n-propyl succinate, di-n-propyl 2,3-diisopropyl succinate, diisopropyl 2,3-di-n-propyl succinate, 2, diisopropyl 3-diisopropyl succinate, di-n-butyl 2,3-di-n-propyl succinate, di-n-butyl 2,3-diisopropyl succinate, diisobutyl 2,3-di-n-propyl succinate, and diisobutyl 2,3-diisopropyl succinate are preferably used.

The first solid catalyst component for polymerizing olefins constituting the solid catalyst component mixture for polymerizing olefins according to the present invention has a succinate diester compound content ratio expressed as mass % in terms of solid content of preferably 5 to 28 mass %, more preferably 10 to 24 mass %, and still more preferably 15 to 20 mass %.

The first solid catalyst component for polymerizing olefins constituting the solid catalyst component mixture for polymerizing olefins according to the present invention has a succinate diester compound content ratio expressed as mol % in terms of solid content of preferably 0.019 to 0.108 mol %, more preferably 0.039 to 0.093 mol %, and still more preferably 0.058 to 0.077 mol %.

The first solid catalyst component for polymerizing olefins constituting the solid catalyst component mixture for polymerizing olefins according to the present invention has a ratio expressed by the content ratio (D1) of the succinate diester compound to the content ratio (T) of titanium, i.e. (D1/T) expressed as mass ratio, of preferably 3.5 to 6.6, more preferably 4.1 to 6.0, and still more preferably 4.8 to 5.4.

The first solid catalyst component for polymerizing olefins constituting the solid catalyst component mixture for polymerizing olefins according to the present invention has a ratio expressed by the content ratio (D1) of the succinate diester compound to the content ratio (T) of titanium, i.e. (D1/T) expressed in molar ratio, of preferably 0.3 to 1.3, more preferably 0.5 to 1.2, and still more preferably 0.7 to 1.1.

In the case where the first solid catalyst component for polymerizing olefins constituting the solid catalyst component mixture for polymerizing olefins according to the present invention is used for polymerization of olefins, due to having a succinate diester compound content ratio in terms of solid content, or a ratio expressed by the content ratio (D1) of the succinate diester compound to the content ratio (T) of titanium, i.e. (D1/T), controlled in the range, a polymer of olefins excellent in melt flowability and further excellent in flexural modulus can be easily produced.

The first solid catalyst component for polymerizing olefins constituting the solid catalyst component mixture for polymerizing olefins according to the present invention contains a succinate diester compound as an internal electron-donating compound that is an essential component, and may further contain other internal electron-donating compounds (hereinafter appropriately referred to as “other internal electron-donating compounds”) in addition to the internal electron-donating compound described above.

Examples of the other internal electron-donating compounds include one or more selected from carbonates, acid halides, acid amides, nitriles, acid anhydrides, diether compounds, and carboxylate esters.

Specific examples of the other internal electron-donating compounds include one or more selected from ether carbonate compounds, carbonate diesters such as cycloalkane dicarboxylate diesters, cycloalkene dicarboxylate diesters, malonate diesters, alkyl-substituted malonate diesters, and maleate diesters, and diether compounds.

More specifically, one or more selected from ether carbonate compounds such as (2-ethoxyethyl)methyl carbonate, (2-ethoxyethyl)ethyl carbonate, and (2-ethoxyethyl)phenyl carbonate, dialkyl malonate diester such as dimethyl diisobutyl malonate and diethyl diisobutyl malonate, cycloalkane dicarbonate diesters such as dimethyl cyclohexane-1,2-dicarbonate, and 1,3-diethers such as (isopropyl)(isopentyl)-1,3-dimethyoxy propane and 9,9-bis(methoxy methyl) fluorene are more preferred.

On the other hand, the first solid catalyst component for polymerizing olefins constituting the solid catalyst component mixture for polymerizing olefins according to the present invention has a phthalate diester compound content ratio of suitably 0.2 mass % or less (0.0 to 0.2 mass %), more suitably 0.1 mass % or less (0.0 to 0.1 mass %), and particularly suitably 0.0 mass % (containing substantially no phthalate diester compound (below detection limit)).

In the present application document, the content ratio of the succinate diester compound contained in the solid catalyst component for polymerizing olefins, the content ratio of other internal electron-donating compounds added on an as needed basis, and the content ratio of the phthalate diester compound (to be described as follows) are values in terms of solid content obtained by drying the solid catalyst component for polymerizing olefins through heating under reduced pressure to completely remove the solvent component in advance, then hydrolyzing the component, and subsequently extracting the succinate diester compound, the other internal electron-donating compounds added on an as needed basis, and phthalate diester compound using an aromatic solvent, and measuring the solution by gas chromatography FID (Flame Ionization Detector) method.

As described above, in the present application document, “in terms of solid content” means calculating the content ratio of each component based on the solid content with liquid components such as solvent completely removed.

The first solid catalyst component for polymerizing olefins constituting the solid catalyst component mixture for polymerizing olefins according to the present invention has a titanium content in terms of atomic weight of preferably 2.0 to 5.0 mass %, more preferably 2.5 to 4.5 mass %, and still more preferably 3.5 to 4.5 mass %.

The first solid catalyst component for polymerizing olefins constituting the solid catalyst component mixture for polymerizing olefins according to the present invention has a magnesium content in terms of atomic weight of preferably 15.0 to 25.0 mass %, more preferably 16.0 to 23.0 mass %, still more preferably 17.0 to 22.0 mass %, and further preferably 17.0 to 21.0 mass %.

The first solid catalyst component for polymerizing olefins constituting the solid catalyst component mixture for polymerizing olefins according to the present invention has a halogen content terms of atomic weight of preferably 50.0 to 70.0 mass, more preferably 55.0 to 68.0 mass %, still more preferably 58.0 to 67.0 mass %, and further preferably 60.0 to 66.0 mass %.

In the present application document, the content ratio of titanium atoms contained in the solid catalyst component for polymerizing olefins is a value obtained according to the method described in JIS 8311-1997 “Method for quantifying titanium in titanium ore (oxidation-reduction titration)” by using the solid catalyst component for polymerizing olefins dried through heating under reduced pressure to completely remove the solvent component in advance.

Also, in the present application document, the content ratio of magnesium atoms in the solid catalyst component for polymerizing olefins is a value obtained by drying the solid catalyst component for polymerizing olefins through heating under reduced pressure to completely remove the solvent component in advance, then dissolving the components in a hydrochloric acid solution to be measured by an EDTA titration method in which titration is performed using an EDTA solution.

Also, in the present application document, the content ratio of halogen atoms contained in the solid catalyst component for polymerizing olefins is a value obtained by drying the solid catalyst component for polymerizing olefins through heating under reduced pressure to completely remove the solvent component in advance, then treating the components with a mixture solution of sulfuric acid and pure water to make an aqueous solution, and fractionating a predetermined amount of the aqueous solution to be measured by a silver nitrate titration method in which halogen is titrated with a standard silver nitrate solution.

The first solid catalyst component for polymerizing olefins constituting the solid catalyst component mixture for polymerizing olefins according to the present invention contains magnesium, titanium, halogen, a succinate diester compound, and on an as needed basis, other internal electron-donating compounds, and may further contain a polysiloxane.

Since the first solid catalyst component for polymerizing olefins constituting the solid catalyst component mixture for polymerizing olefins according to the present invention contains a polysiloxane, the stereoregularity or crystallinity of the resulting polymer obtained by polymerization can be easily improved, and furthermore, the amount of fine powder of the resulting polymer can be easily reduced in polymerizing olefins.

Polysiloxane is a polymer having a siloxane bond (—Si—O— bond) in the main chain, and is also referred to as silicone oil, which is a chainlike, partially hydrogenated, cyclic or modified polysiloxane that is liquid or viscous at room temperature, having a viscosity at 25° C. of 0.02 to 100.00 cm²/s (2 to 10000 centistokes), more preferably 0.03 to 5.00 cm²/s (3 to 500 centistokes).

Examples of the chainlike polysiloxane include dimethyl polysiloxane and methylphenyl polysiloxane, examples of the partially hydrogenated polysiloxane include methyl hydrogen polysiloxanes with a hydrogenation rate of 10 to 801, and examples of the cyclic polysiloxane include one or more selected from hexamethyl cyclotrisiloxane, octamethyl cyclotetrasiloxane, decamethyl cyclopentasiloxane, 2,4,6-trimethyl cyclotrisiloxane and 2,4,6,8-tetramethyl cyclotetrasiloxane.

The solid catalyst component mixture for polymerizing olefins according to the present invention includes a second solid catalyst component for polymerizing olefins together with the first solid catalyst component for polymerizing olefins.

Examples of the second solid catalyst component for polymerizing olefins constituting the solid catalyst component mixture for polymerizing olefins according to the present invention include a contact reaction product obtained by contacting and reacting raw material components serving as supply sources of magnesium, titanium and halogen with a phthalate diester compound as internal electron-donating compound to each other in an organic solvent. Specific examples include a contact reaction product obtained by contacting raw material components including magnesium compound and a tetravalent titanium halogen compound as supply source of magnesium, titanium and halogen with an internal electron-donating compound containing a phthalate diester compound to each other.

Specific examples of the magnesium compound and the tetravalent titanium halogen compound include the same ones as those in the description of the first solid catalyst component for polymerizing olefins.

In the second solid catalyst component for polymerizing olefins constituting the solid catalyst mixture for polymerizing olefins according to the present invention, the phthalate diester compound is preferably a phthalate diester.

Examples of the phthalate diester include one or more selected from dimethyl phthalate, diethyl phthalate, di-n-propyl phthalate, diisopropyl phthalate, di-n-butyl phthalate, diisobutyl phthalate, methylethyl phthalate, (ethyl)n-propyl phthalate, ethyl isopropyl phthalate, ethyl)n-butyl phthalate, and ethyl isobutyl phthalate.

The second solid catalyst component for polymerizing olefins constituting the solid catalyst component mixture for polymerizing olefins according to the present invention has a phthalate diester compound content ratio in terms of solid content represented in mass % of preferably 8.0 to 20.0 mass %, more preferably 9.0 to 17.5 mass %, and still more preferably 10.0 to 15.0 mass %.

The second solid catalyst component for polymerizing olefins constituting the solid catalyst component mixture for polymerizing olefins according to the present invention has a phthalate diester compound content ratio in terms of solid content represented in mol % of preferably 2.7 to 5.6 mol %, more preferably 3.6 to 5.3 mol %, and still more preferably 4.5 to 5.0 mol %.

The second solid catalyst component for polymerizing olefins constituting the solid catalyst component mixture for polymerizing olefins according to the present invention has a ratio expressed by the content ratio (D2) of the phthalate diester compound to the content ratio (T) of titanium, i.e. (D2/T) expressed as mass ratio, of preferably 0,025 to 0.072, more preferably 0.030 to 0.063, and still more preferably 0.035 to 0.054.

The second solid catalyst component for polymerizing olefins constituting the solid catalyst component mixture for polymerizing olefins according to the present invention has a ratio expressed by the content ratio (D2) of the phthalate diester compound to the content ratio (T) of titanium, i.e. (D2/T) expressed in molar ratio, of preferably 0.3 to 1.3, more preferably 0.5 to 1.2, and still more preferably 0.7 to 1.1.

In the case where the second solid catalyst component for polymerizing olefins constituting the solid catalyst component mixture for polymerizing olefins according to the present invention is used for polymerizing olefins, due to having a phthalate diester compound content ratio in terms of solid content, or a ratio expressed by the content ratio (D2) of the phthalate diester compound to the content ratio (T) of titanium, i.e. (D2/T), controlled in the range, a polymer of olefins excellent in melt flowability and further excellent in flexural modulus can be easily produced.

The second solid catalyst component for polymerizing olefins constituting the solid catalyst component mixture for polymerizing olefins according to the present invention contains a phthalate diester compound as an internal electron-donating compound that is an essential component, and may further contain other internal electron-donating compounds in addition to the internal electron-donating compound described above. Examples of the other internal electron-donating compounds include the same ones as in the description of the first solid catalyst component for polymerizing olefins.

The second solid catalyst component for polymerizing olefins constituting the solid catalyst component for polymerizing olefins according to the present invention has a succinate diester compound content ratio of suitably 0.2 mass % or less (0.0 to 0.2 mass %), more suitably 0.1 mass % or less (0.0 to 0.1 mass %), and particularly suitably 0.0 mass % (containing substantially no succinate diester (below detection limit)).

The second solid catalyst component for polymerizing olefins constituting the solid catalyst component mixture for polymerizing olefins according to the present invention has a titanium content in terms of atomic weight of preferably 2.0 to 5.0 mass %, more preferably 2.5 to 4.5 mass %, and still more preferably 3.5 to 4.5 mass %.

The second solid catalyst component for polymerizing olefins constituting the solid catalyst component mixture for polymerizing olefins according to the present invention has a magnesium content in terms of atomic weight of preferably 15.0 to 25.0 mass&, more preferably 16.0 to 23.0 mass %, still more preferably 17.0 to 22.0 mass %, and further preferably 17.0 to 21.0 mass %.

The second solid catalyst component for polymerizing olefins constituting the solid catalyst component mixture for polymerizing olefins according to the present invention has a halogen content terms of atomic weight of preferably 50.0 to 70.0 mass %, more preferably 55.0 to 68.0 mass %, still more preferably 58.0 to 67.0 mass %, and further preferably 60.0 to 66.0 mass %.

The method for measuring the content ratio of each constituent of the second solid catalyst component for polymerizing olefins is the same as in the description of the first solid catalyst component for polymerizing olefins.

The second solid catalyst component for polymerizing olefins constituting the solid catalyst component mixture for polymerizing olefins according to the present invention may contain a polysiloxane, and specific examples of the polysiloxane include the same ones as in the description of the first solid catalyst component for polymerizing olefins.

The solid catalyst component mixture for polymerizing olefins comprises a first solid catalyst component for polymerizing olefins and a second solid catalyst component for polymerizing olefins at a mass ratio of First solid catalyst component for polymerizing olefins:Second solid catalyst component for polymerizing olefins=37:63 to 87:13, preferably 37:63 to 86:14, more preferably 37:63 to 85:15.

Incidentally, the solid, catalyst component mixture for polymerizing olefins according to the present invention contains only the first solid catalyst component for polymerizing olefins and the second solid catalyst component for polymerizing olefins.

Since the solid catalyst component mixture for polymerizing olefins according to the present invention contains the first solid catalyst component for polymerizing olefins and the second solid catalyst component for polymerizing olefins at the ratio described above, when used to polymerize to polymerize olefins, a polymer of olefins having excellent melt flowability and flexural modulus can be more effectively produced.

In the solid catalyst component mixture for polymerizing olefins according to the present invention, a succinate diester compound is employed as internal electron-donating compound constituting the first solid catalyst component for polymerizing olefins, while a phthalate diester compound is employed as internal electron-donating compound constituting the second solid catalyst component for polymerizing olefins.

In the solid catalyst component mixture for polymerizing olefins according to the present invention, the content ratio of the succinate diester compound in terms of solid content is preferably 4.7 to 14.9 mass %, more preferably 4.7 to 14.6 mass %, and still more preferably 4.7 to 14.3 mass %.

Furthermore, in the solid catalyst component mixture for polymerizing olefins according to the present invention, the content ratio of the phthalate diester compound in terms of solid content is preferably 2.2 to 7.9 mass %, more preferably 2.3 to 7.9 mass %, and still more preferably 2.5 to 7.9 mass %.

In the solid catalyst component mixture for polymerizing olefins according to the present invention, since the content ratios of the succinate diester compound and the phthalate diester compound are in the ranges described above, when used to polymerize olefins, a polymer of olefins having excellent melt flowability and rigidity can be easily produced.

Conventionally, a succinate diester compound itself is expensive for use as internal electron-donating compound of a solid catalyst component for polymerizing olefins, and when used for polymerizing olefins, the compound has been presumed to hardly improve the stereoregularity of the resulting polymer of olefins. Accordingly, daring use of a succinate diester compound as internal electron-donating compound in a solid catalyst component for polymerizing olefins has not been attempted.

However, through extensive study, the present inventors have found that use of a solid catalyst component for polymerizing olefins containing a succinate diester compound as internal electron-donating compound for polymerizing olefins allows a polymer of olefins having excellent flexural modulus (FM) to be produced.

On the other hand, through study of the polymer of olefins obtained using the solid catalyst component for polymerizing olefins containing a succinate diester compound as internal electron-donating compound by the present inventors, it has been found that in the case of producing a polypropylene having a flexural modulus (FM) of 1900 MPa or more, the melt flowability (melt flow rate (MFR)) of the resulting polypropylene tends to extremely easily decrease.

Under these circumstances, the present inventors have adopted a first solid catalyst component for polymerizing olefins that contain a succinate diester compound as internal electron-donating compound, and a second solid catalyst component for polymerizing olefins that contain a phthalate diester compound as internal electron-donating compound. It has been found that in polymerization of olefins, using a mixture containing the first solid catalyst component for polymerizing olefins and the second solid catalyst component for polymerizing olefins at a predetermined ratio instead of the conventional solid catalyst component for polymerizing olefins allows a polymer of olefins having a higher flexural modulus than conventional ones to be produced with excellent melt flowability ensured. Accordingly, the present invention has been completed.

It is presumed that use of a solid catalyst component mixture for polymerizing olefins containing a plurality of internal electron-donating compounds in polymerization of olefins produces a plurality of polymers of olefins depending on the respective a solid catalyst component for polymerizing olefins. Usually, polymers of olefins with significantly different physical properties tend to be hardly mixed with each other, and therefore are generally not practical.

On the other hand, in the solid catalyst component mixture for polymerizing olefins according to the present invention, a mixture containing a first solid catalyst component for polymerizing olefins and a second solid catalyst component for polymerizing olefins at a predetermined ratio is used for polymerization of olefins. As a result, it is presumed that the first solid catalyst component for polymerizing olefins produces a first polymer of olefins having an excellent flexural modulus and a wide molecular weight distribution, which exhibits high compatibility with a second polymer of olefins produced from the second solid catalyst component for polymerizing olefins. It is presumed that the resulting polymer of olefins (mixture of the first polymer of olefins and the second polymer of olefins) can exhibit excellent melt flowability without greatly decrease in the high flexural modulus exclusively exhibited by the first polymer of olefins.

As described above, in the present invention, by using a specific solid catalyst component mixture for polymerizing olefins instead of a conventional solid catalyst component for polymerizing olefins, a polymer of olefins having both high melt flowability and rigidity can be easily produced without requiring a large amount of energy cost and without increasing the number of steps.

The solid catalyst component mixture for polymerizing olefins according to the present invention may be prepared by mixing a first solid catalyst component for polymerizing olefins and a second solid catalyst component for polymerizing olefins in advance to be supplied in a mixture state for polymerization of olefins. Alternatively, the first solid catalyst component for polymerizing olefins and the second solid catalyst component for polymerizing olefins may be separately fed into a polymerization system of olefins such that a mixture may be formed in the polymerization system.

The first solid catalyst component for polymerizing olefins and the second solid catalyst component for polymerizing olefins that constitute the solid catalyst component mixture for polymerizing olefins according to the present invention each can be produced by a conventionally known method.

The first solid catalyst component for polymerizing olefins and the second solid catalyst component for polymerizing olefins that constitute the solid catalyst component mixture for polymerizing olefins according to the present invention each are different in whether they contain a succinate diester compound as internal electron-donating compound that is an essential constituent or a phthalate diester compound as internal electron-donating compound that is an essential constituent, and are common in other respects. Accordingly, as the production methods of the first solid catalyst component for polymerizing olefins and the second solid catalyst component for polymerizing olefins, the methods different in whether a succinate diester compound is used as an internal electron-donating compound that is an essential constituent or a phthalate diester compound is used as an internal electron-donating compound that is an essential constituent, and common in other respects, may be employed.

It is preferable that the first solid catalyst component for polymerizing olefins or the second solid catalyst component for polymerizing olefins constituting a solid catalyst component mixture for polymerizing olefins according to the present invention be prepared by contacting the dialkoxy magnesium, titanium halogen compound, and internal electron-donating compound (either one of a succinate diester compound and a phthalate diester compound as essential component) with each other together with other components on an as needed basis in the presence of an inert organic solvent.

In the present invention, the inert organic solvent is preferably one that dissolves the titanium halogen compound without dissolving dialkoxy magnesium, and specific examples thereof include one or more selected from saturated hydrocarbon compounds such as pentane, hexane, heptane, octane, nonane, decane, cyclohexane, methyl cyclohexane, ethyl cyclohexane, 1,2-diethyl cyclohexane, methyl cyclohexene, decalin and mineral oil; aromatic hydrocarbon compounds such as benzene, toluene, xylene and ethylbenzene; and halogenated hydrocarbon compounds such as orthodichlorobenzene, methylene chloride, 1,2-dichlorobenzene, carbon tetrachloride and dichloroethane.

As the inert organic solvent, saturated hydrocarbon compounds or aromatic hydrocarbon compounds in a liquid state at room temperature, having a boiling point of about 50 to 200° C., are preferably used. Among them, one or more selected from hexane, heptane, octane, ethylcyclohexane, mineral oil, toluene, xylene, and ethylbenzene are preferred, and one or more selected from hexane, heptane, ethylcyclohexane and toluene are particularly preferred.

Examples of the method for producing a solid catalyst component for polymerizing olefins constituting the catalyst for polymerizing olefins according to the present invention include a method for obtaining a target solid catalyst component for polymerizing olefins (hereinafter referred to as production method “a” of a solid catalyst component) comprising preparing a first solid catalyst component for polymerizing olefins or a second solid catalyst component for polymerizing olefins by contacting dialkoxy magnesium, titanium halogen compound and an internal electron-donating compound (either one of a succinate diester compound and a phthalate diester compound is essential component) with each other,
wherein the titanium halogen compound is contacted with dialkoxy magnesium multiple times,
wherein when initially contacting the titanium halogen halogen compound with dialkoxy magnesium, 1.5 to 10.0 mol of the titanium halogen compound is used per 1 mol of dialkoxy magnesium,
wherein the total amount of the titanium compound used is 5.0 to 18.0 mol per 1 mol of the dialkoxy magnesium, and
the amount of the succinate diester compound or phthalate diester compound used is 0.10 to 0.20 mol per mol of the dialkoxy magnesium.

In the production method “a” of the solid catalyst component, the titanium halogen compound is contacted with dialkoxy magnesium multiple times. When the titanium halogen halogen compound is contacted with dialkoxy magnesium for the first time, the amount of the titanium halogen compound used relative to 1 mol, of dialkoxy magnesium is preferably 1.5 to 10.0 mol, more preferably 2.0 to 8.0 mol, and still more preferably 2.0 to 5.0 mol.

In the production method “a” of the solid catalyst component, by controlling the amount of titanium halogen compound used relative to dialkoxy magnesium within the range, a solid catalyst component for polymerizing olefins having high activity can be prepared with a small amount of titanium halogen compound.

In the production method “a” of the solid catalyst component, the total amount of the titanium compound used is 5.0 to 18.0 mol per mol of dialkoxy magnesium, preferably 5.0 to 15.0 mol per mol of dialkoxy magnesium, and more preferably 5.0 to 10.0 mol per mol of dialkoxy magnesium.

In the production method “a” of the solid catalyst component, by controlling the total amount of titanium compounds used per mol of dialkoxy magnesium within the range, a carrier capable of optimally supporting the titanium halogen compound and succinate diester compound can be prepared while ensuring sufficiently high activity.

In the production method “a” of the solid catalyst component, 0.10 to 0.20 mol of a succinate diester compound or a phthalate diester compound is used per mol of dialkoxy magnesium. It is preferable that 0.10 to 0.18 mol of a succinate diester compound or a phthalate diester compound be used per mol of dialkoxy magnesium, and it is more preferable that 0.10 to 0.15 mol of the succinate diester compound or phthalate diester compound be used per mol of dialkoxy magnesium.

In the production method “a” of the solid catalyst component, by controlling the amount of the succinate diester compound or phthalate diester compound used per 1 mol of dialkoxy magnesium within the range, the succinate diester compound or the phthalate diester compound can be sufficiently supported, without supporting of an excessive amount of titanium halogen compound on the carrier.

More specific examples of the production method “a” of the solid catalyst component include the steps of suspending dialkoxy magnesium, a titanium halogen compound and a succinate diester compound or a phthalate diester compound in an inert hydrocarbon solvent to be contacted with each other for a predetermined period of time while heating, then further adding a titanium halogen compound to the resulting suspension for contacting the mixture to obtain a solid product while heating, and washing the solid product with a hydrocarbon solvent to obtain a target solid catalyst component for polymerizing olefins.

The heating temperature is preferably 70 to 150° C., more preferably 80 to 120° C., still more preferably 90 to 110° C.

The heating time period is preferably 30 to 240 minutes, more preferably 60 to 180 minutes, still more preferably 60 to 120 minutes.

The number of times of adding the titanium halogen compound to the suspension is not particularly limited.

In the case of adding the titanium halogen compound multiple times to the suspension, each of the heating temperature may be controlled in the range, and the heating time period for each addition may be controlled in the range.

Incidentally, in the preparation method, while adding the succinate diester compound or the phthalate diester compound as internal electron-donating compound, other internal electron-donating compounds may be further added. Furthermore, the contact may be performed under coexistence of other reaction reagents such as silicon, phosphorus and aluminum, and a surfactant.

According to the present invention, it is possible to provide a solid catalyst component mixture for polymerizing olefins from which a polymer of olefins having both high melt flowability and rigidity can be easily produced.

Subsequently, the catalyst for polymerizing olefins according to the present invention is described.

The catalyst for polymerizing olefins according to the present invention comprises one or more organic aluminum compounds selected from:
(I) a solid catalyst component mixture for polymerizing olefins according to the present invention, and
(II) a compound represented by the following general formula (1)

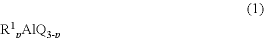

wherein R¹ is an alkyl group having 1 to 6 carbon atoms, Q is a hydrogen atom or a halogen atom, and p satisfies 0<p≤3.

In the catalyst for polymerizing olefins according to the present invention, the details of the solid catalyst component mixture for polymerizing olefins according to the present invention (I) are as described above.

The catalyst for polymerizing olefins according to the present invention comprises one or more organic aluminum compounds selected from:

(II) a compound represented by the following general formula (1)

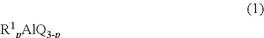

wherein R¹ is an alkyl group having 1 to 6 carbon atoms, Q is a hydrogen atom or a halogen atom, and p satisfies 0<p≤3; in the case where a plurality of R¹ is present, R¹ may be the same or different from each other, and in the case where a plurality of Q is present, Q may be the same or different from each other.

In the compound represented by the general formula (1), p satisfies 0<p≤3, and specific examples of p include 1, 2 and 3.

Specific examples of the organic aluminum compound represented by the general formula (1) include one or more selected from trialkyl aluminum such as triethyl aluminum, triisopropyl aluminum, tri-n-butyl aluminum, tri-n-hexyl aluminum and triisobutyl aluminum; one or more selected from halogenated alkyl aluminum such as diethyl aluminum chloride and diethyl aluminum bromide; and diethyl aluminum hydride. One or more selected from a halogenated alkyl aluminum such as diethyl aluminum chloride and a trialkyl aluminum such as triethyl aluminum, tri-n-butyl aluminum and triisobutyl aluminum are preferred, and one or more selected from triethyl aluminum and triisobutyl aluminum are more preferred.

It is preferable that the catalyst for polymerizing olefins according to the present invention contain an external electron-donating compound (III).

In the catalyst for polymerizing olefins according to the present invention, examples of the external electron-donating compound (III) include a silicon compound represented by the following general formula (4):

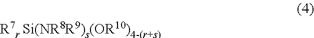

wherein r is 0 or 1 to 2, s is 0 or 1 to 2, r+s is 0 or 1 to 4, R⁷, R⁸ or R⁹ may be a hydrogen atom or any group selected from a straight-chain or branched alkyl group having 1 to 12 carbon atoms, a substituted or unsubstituted cycloalkyl group, a phenyl group, an allyl group, and an aralkyl group, which may contain a heteroatom and may be the same or different from each other; R⁸ and R⁹ may be combined to form a ring shape, and R⁷, R⁸ and R⁹ may be the same or different from each other; R¹⁰ is any group selected from an alkyl group having 1 to 4 carbon atoms, a cycloalkyl group, a phenyl group, a vinyl group, an allyl group, and an aralkyl group, which may contain a hetero atom.

In the silicon compound represented by the general formula (4), R⁷ is a hydrogen atom or any group selected from a straight-chain or branched alkyl group having 1 to 12 carbon atoms, a substituted or unsubstituted cycloalkyl group, a phenyl group, an allyl group, and an aralkyl group, which may contain a heteroatom.

R⁷ is preferably a straight-chain or branched alkyl group having 1 to 10 carbon atoms or a cycloalkyl group having 5 to 8 carbon atoms, particularly preferably a straight-chain or branched alkyl group having 1 to 8 carbon atoms and a cycloalkyl group having 5 to 8 carbon atoms.

In the silicon compound represented by the general formula (4), R⁸ or R⁹ is a hydrogen atom or any group selected from a straight-chain or branched alkyl group having 1 to 12 carbon atoms, a substituted or unsubstituted cycloalkyl group, a phenyl group, an allyl group, and an aralkyl group, which may contain a heteroatom.

R⁸ or R⁹ is preferably a straight-chain or branched alkyl group having 1 to 10 carbon atoms or a cycloalkyl group having 5 to 8 carbon atoms, particularly preferably a straight-chain or branched alkyl group having 1 to 8 carbon atoms or a cycloalkyl group having 5 to 8 carbon atoms.

Further, R⁸ and R⁹ may be combined to form a ring shape, and in this case, (NR⁸R⁹) that forms a ring shape is preferably a perhydroquinolino group or a perhydroisoquinolino group.

In the silicon compound represented by the general formula (4), R⁷, R⁸ and R⁹ may be the same or different from each other.

In the silicon compound represented by the general formula (4), R¹⁰ is any group selected from an alkyl group having 1 to 4 carbon atoms, a cycloalkyl group, a phenyl group, an allyl group, and an aralkyl group, and may contain a heteroatoms.

R¹⁰ is preferably a straight-chain or branched alkyl group having 1 to 4 carbon atoms.

In the silicon compound represented by the general formula (4), r is 0 or 1 to 2, and specific examples of r include 0, 1 and 2.

In the silicon compound represented by the general formula (4), s is 0 or 1 to 2, and specific examples of a include 0, 1 and 2.

In the silicon compound represented by the general formula (4), r+s is 0 or 1 to 4, and specific examples of r+s include 0, 1, 2, 3 and 4.

Specific examples of the silicon compound represented by the general formula (4) include one or more organic silicon compounds selected from phenyl alkoxysilane, alkyl alkoxysilane, phenyl alkyl alkoxysilane, cycloalkyl alkoxysilane, cycloalkyl alkyl alkoxysilane, (alkylamino)alkoxysilane, alkyl(alkylamino)alkoxysilane, alkyl(alkylamino)silane and alkylamino silane.

Particularly preferable examples of the silicon compound represented by the general formula (4) with s of 0 include one or more organic silicon compound selected from di-n-propyl dimethoxysilane, diisopropyl dimethoxysilane, di-n-butyl dimethoxysilane, diisobutyl dimethoxysilane, di-t-butyl dimethoxysilane, t-butyl methyl dimethoxysilane, t-butyl ethyl dimethoxysilane, di-n-butyl diethoxysilane, t-butyl trimethoxysilane, t-butyl triethoxysilane, dicyclohexyl dimethoxysilane, dicyclohexyl diethoxysilane, cyclohexyl methyl dimethoxysilane, cyclohexyl methyl diethoxysilane, cyclohexyl ethyl dimethoxysilane, cyclohexyl ethyl diethoxysilane, dicyclopentyl dimethoxysilane, dicyclopentyl diethoxysilane, cyclopentyl methyl dimethoxysilane, cyclopentyl methyl diethoxysilane, cyclopentyl ethyl diethoxysilane, cyclohexyl cyclopentyl dimethoxysilane, cyclohexyl cyclopentyl diethoxysilane, 3-methyl cyclohexyl cyclopentyl dimethoxysilane, 4-methyl cyclohexyl cyclopentyl dimethoxysilane, and 3,5-dimethyl cyclohexyl cyclopentyl dimethoxysilane.

Examples of the silicon compound represented by the general formula (4) with s of 1 or 2 include one or more organic silicon compounds selected from di(alkylamino)dialkoxysilane, (alkylamino)(cycloalkyl amino)dialkoxysilane, (alkylamino)(alkyl)dialkoxysilane, di(cycloalkyl amino dialkoxysilane, vinyl(alkylamino)dialkoxysilane, allyl(alkylamino)dialkoxysilane, (alkoxyamino)trialkoxysilane, (alkylamino)trialkoxysilane and (cycloalkyl amino)trialkoxysilane; and ethyl(t-butylamino)dimethoxysilane, cyclohexyl(cyclohexyl amino)dimethoxysilane, ethyl(t-butylamino)dimethoxysilane, bis(cyclohexyl amino)dimethoxysilane, bis(perhydroisoquinolino)dimethoxysilane, bis(perhydroquinolino)dimethoxysilane, ethyl(isoquinolino)dimethoxysilane, diethylamino trimethoxysilane, diethylamino triethoxysilane are particularly preferred. Among them, one or more organic silicon compounds selected from bis(perhydroisoquinolino)dimethoxysilane, diethylamino trimethoxysilane, and diethylamino triethoxysilane are most preferred.

Incidentally, two or more silicon compounds represented by the general formula (4) may be used in combination.

The catalyst for polymerizing olefins according to the present invention comprises (I) a solid catalyst component for polymerizing olefins according to the present invention, (II) an organic aluminum compound represented by the general formula (2), and on an as needed basis, (III) an external electron-donating compound, i.e. a contacted product thereof.

The catalyst for polymerizing olefins according to the present invention may be prepared by contacting (1) a solid catalyst component for polymerizing olefins according to the present invention, (II) an organic aluminum compound represented by the general formula (2), and on an as needed basis, (III) an external electron-donating compound in the absence of olefins, or may be prepared by contacting them (in a polymerization system) in the presence of olefins as described below.

In the catalyst for polymerizing olefins according to the present invention, the content ratio of each component is arbitrary and not particularly limited as long as the effects of the present invention are not affected. Usually, the catalyst for polymerizing olefins according to the present invention contains the organic aluminum compound (II) in an amount of preferably 1 to 2000 mol, more preferably 50 to 1.000 mol, per mol of titanium atoms in the solid catalyst component mixture for polymerizing olefins (I). Further, the catalyst for polymerizing olefins according to the present invention contains the external electron-donating compound (Ill) in an amount of preferably 0.002 to 10.000 mol, more preferably 0.010 to 2.000 mol, still more preferably 0.010 to 0.500 mol, per mol of the organic aluminum compound (II).

According to the present invention, it is possible to provide a catalyst for polymerizing olefins that allows a polymer of olefins having both high melt flowability and rigidity to be easily produced.

Subsequently, the production method of a polymer of olefins according to the present invention is explained.

The production method of a polymer of olefins according to the present invention comprises polymerizing olefins by using the catalyst for polymerizing olefins according to the present invention.

In the production method of a polymer of olefins according to the present invention, the polymerization of olefins may be homopolymerization or copolymerization.

In the production method of a polymer of olefins according to the present invention, the olefins to be polymerized is one or more selected from ethylene, propylene, 1-butene, 1-pentene, 4-methyl-1-pentene, and vinylcyclohexane. Of these, one or more selected from ethylene, propylene and 1-butene are suitable, and propylene is more suitable.

In the case where the olefin is propylene, homopolymerization of propylene, or copolymerization of propylene with other α-olefins may be performed.

Examples of the olefins copolymerized with propylene include one or more selected from ethylene, 1-butene, 1-pentene, 4-methyl-1-pentene and vinylcyclohexane.

In the case where the catalyst for polymerizing olefins according to the present invention is prepared in the presence of olefins (in a polymerization system), the usage ratio of each component is arbitrary and not particularly limited as long as the effects of the present invention are not affected. The organic aluminum compound in an amount of preferably 1 to 2000 mol, more preferably in an amount of 50 to 1000 mol, is contacted with 1 mole of titanium atom in the solid catalyst component mixture for polymerizing olefins. Further, the external electron-donating compound selected from the silicon compounds represented by the general formula (4) described above in an amount of preferably 0.002 to 10.000 mol, more preferably 0.01 to 2 mol, still more preferably 0,010 to 0.500 mol, is contacted with 1 mol of the organic aluminum compound.

The order of contacting the components constituting the catalyst for polymerizing olefins is arbitrary. Preferably, the organic aluminum compound is first fed into the polymerization system, and an external electron-donating compound is then fed on an as needed basis. After contacting, the solid catalyst component mixture for polymerizing olefins described above is fed and contacted.

The solid catalyst component mixture for polymerizing olefins may be prepared by mixing the first solid catalyst component for polymerizing olefins and the second solid catalyst component for polymerizing olefins. The resulting mixture may be fed into a polymerization system. Alternatively, the first solid catalyst component for polymerizing olefins and the second solid catalyst component for polymerizing olefins may be fed separately to form a mixture in a polymerization system.

The production method of a polymer of olefins according to the present invention may be performed in the presence or absence of an organic solvent.

Further, olefin monomers such as propylene may be used in either gas or liquid state. The polymerization temperature is preferably 200° C. or less, more preferably 100° C. or less, and the polymerization pressure is preferably 10 MPa or less, more preferably 5 MPa or less. In addition, the polymerization of olefins may be performed by any one of continuous polymerization method and batch polymerization method. Further, the polymerization reaction may be performed in one stage or in two or more stages.

In addition, in polymerizing olefins using the catalyst for polymerizing olefins according to the present invention (also referred to as main polymerization), preliminary polymerization is preferably performed prior to the main polymerization to further improve catalyst activity, stereoregularity, and particle properties of the resulting polymer etc. In the preliminary polymerization, the same olefins or monomers such as styrene as in the main polymerization may be used.

In the preliminary polymerization, the contact sequence of each of the components constituting the catalyst for polymerizing olefins and the monomers (olefins) is arbitrary. A preferable contact sequence is as follows. Into a preliminary polymerization system set in an inert gas atmosphere or olefin gas atmosphere, first, an organic aluminum compound is fed, and then the solid catalyst component for polymerizing olefins are fed to be contacted. After the contact, olefins such as propylene alone or a mixture of olefins such as propylene and one or more other olefins are contacted.

In the preliminary polymerization, in the case where an external electron-donating compound is further fed into the preliminary polymerization system, a preferable contact sequence is as follows. Into a preliminary polymerization system set in an inert gas atmosphere or olefin gas atmosphere, first, an organic aluminum compound is fed, and then the external electron-donating compound is fed to be contacted. Further, after contact with the solid catalyst component mixture for polymerizing olefins described above, olefins such as propylene alone or a mixture of olefins such as propylene and one or more other olefins are contacted.

In the production method of a polymer of olefins according to the present invention, examples of the polymerization method include a slurry polymerization method using a solvent of inert hydrocarbon compound such as cyclohexane and heptane, a bulk polymerization method using a solvent of liquefied propylene or the like, and a gas phase polymerization method using substantially no solvent, and a bulk polymerization method or a gas phase polymerization method are preferred.

In the case of copolymerizing propylene with other α-olefin monomers, a random copolymerization in which propylene and a small amount of ethylene as comonomer are polymerized in one stage, and a so-called propylene-ethylene block copolymerization in which propylene is homopolymerized in the first stage (in first polymerization tank) and propylene and another α-olefin such as ethylene are copolymerized in a second stage (in second polymerization tank) or in multiple stages (in multiple stage polymerization tank), are typical. The block copolymerization of propylene and another α-olefin is preferred.

The block copolymer obtained by block copolymerization is a polymer containing segments in which two or more monomer compositions change continuously. The copolymer includes two or more types of polymer chains (segments) having a different primary structure of polymer such as monomer species, comonomer species, comonomer composition, comonomer content, comonomer arrangement, stereoregularity, connected in one molecule chain.

In the production method of a polymer of olefins according to the present invention, the block copolymerization reaction of propylene and other α-olefins is usually performed in the presence of the catalyst for polymerizing olefins according to the present invention. In the preceding stage, contact with propylene alone or propylene and a small amount of α-olefin (ethylene or the like) is performed, and in the subsequent stage, contact with propylene and α-olefin (ethylene or the like) is performed.

Incidentally, the polymerization reaction in the preceding stage may be performed multiple times, or the polymerization reaction in the subsequent stage may be repeated multiple times to perform a multistage reaction.

Specifically, in the block copolymerization reaction of propylene and other α-olefins, it is preferable that the polymerization be performed in the preceding stage to have a proportion of the polypropylene portion of 20 to 90 mass % (in the finally obtained copolymer) through adjustment of the polymerization temperature and time, and then, in the subsequent stage, propylene and ethylene or other α-olefins be introduced and the polymerization be performed to have a proportion of rubber such as ethylene-propylene rubber (EPR) of 10 to 80 mass % (in the finally obtained copolymer).

In both the preceding and subsequent stages, the polymerization temperature is preferably 200° C. or less, more preferably 100° C. or less, still more preferably 65 to 80° C., and the polymerization pressure is preferably 10 MPa or less, more preferably 6 MPa or less, and still more preferably 5 MPa or less.

In the copolymerization reaction, either a continuous polymerization method or a batch polymerization method may be employed, and the polymerization reaction may be performed in one stage or in two or more stages.

Further, the polymerization time (residence time in a reactor) is preferably 1 minute to 5 hours in each of the preceding and subsequent polymerization stages, or in continuous polymerization.

Examples of the polymerization method include a slurry polymerization method using a solvent of inert hydrocarbon compound such as cyclohexane and heptane, a bulk polymerization method using a solvent such as liquefied propylene, and a gas phase polymerization methods using substantially no solvent, and a bulk polymerization method or a gas phase polymerization method is suitable,

In particular, an ethylene/propylene block copolymer contains an EPR component (a copolymerized component of ethylene and propylene), and in the case when the EPR component oozes out onto the surface of polymer particles, the particles become sticky (adherence) to worsen flowability. In polymer production equipment, deterioration of the fluidity of particles is a factor that reduces the plant operability. Accordingly, it is desirable to select a production method of a polymer that can suppress oozing of the EPR component onto the particle surface.

In the olefin polymer obtained by the production method according to the present invention, the melt flow rate (MFR), which indicates the melt flowability of a polymer of olefins, may be in a high range that allows the excellent moldability of the polymer of olefins to be maintained. The MR may be 80 to 120 g/10 minutes, preferably 100 to 120 g/10 minutes.

Incidentally, in the present application document, the melt flow rate (MFR) is a value measured based on ASTM D 1238 and JIS K 7210.

The polymer of olefins obtained by the production method according to the present invention has a flexural modulus (FM) of 1900 MPa or more, preferably 1900 to 2500 MPa, more preferably 2000 to 2400 MPa, with the melt flow rate (MFR) described above in a specified range (80 to 120 g/10 minutes).

Due to having a flexural modulus (FM) in the range, the polymer of olefins obtained by the production method according to the present invention can easily exhibit excellent rigidity.

It is known that in a polymer of olefins produced using a catalyst for polymerizing olefins (including a solid catalyst component for polymerizing olefins), the melt flowability (melt flow rate (MFR)) and flexural modulus (FM) are generally in a barter relationship.

Even in the case of producing a polypropylene having a flexural modulus (FM) of 1900 MPa or more using a solid catalyst component for polymerizing olefins containing a succinate diester compound as internal electron-donating compound, the resulting polypropylene tends to have an extremely reduced melt flow rate (MFR).

However, the polymer of olefins obtained by the production method according to the present invention can have a flexural modulus (FM) of 1900 MPa or more, even with the melt flow rate (MFR) in a specified high range of 0 to 120 g/10 minutes.

Incidentally, in the present application document, the flexural modulus (FM) of the copolymer described above is a value (unit: MPa) measured as follows. A multi-purpose test piece type A1 specified in JIS K7139 is injection molded under conditions at a molding temperature of 200° C. and a mold temperature of 40° C. using NEX301113EG manufactured by Nissel Plastic Industrial Co., Ltd. A test piece with a thickness of 4.0 mm, a width of 10.0 mm, and a length of 80.0 mm is cut out from the central part of the test piece. The cut out test piece is conditioned in a constant temperature chamber controlled at 23° C. for 72 hours. The measurement is then performed in the measurement atmosphere at 23° C. based on JIS K7171.

Since the polymer of olefins obtained by the production method according to the present invention satisfies the flexural modulus specification described above, excellent rigidity can be easily exhibited.

Further, the polymer of olefins obtained by the production method according to the present invention has a proportion (F) of the oriented layer in the cross section of the injection molded product made of the polymer of olefins of preferably 16.0 to 28.0%, more preferably 18.0 to 28.0%, such that the excellent rigidity of the polymer of olefins can be maintained.

Here, in the present application document, the oriented layer in the cross section of the injection molded product made of the polymer of olefins means a surface layer (also referred to as skin layer) having a high degree of birefringence. In the cross section of the injection molded product, the oriented layer described above and an internal non-oriented layer (also referred to as core layer) are formed, and each is visually identified as a clearly separated layer. Since the oriented layer is highly oriented, it is expected that the modulus of elasticity and strength are high. As a result, it is presumed that the molded product with a moderately thick oriented layer has a higher modulus of elasticity and strength of the whole. On the other hand, an injection molded product with a too thin oriented layer has an insufficient elastic modulus and strength, while an injection molded product with a too thick oriented layer loses the balance between the oriented layer and the non-oriented layer. In both cases, fractures occur easily. The polymer of olefins obtained by the production method according to the present invention has a proportion (F) of the oriented layer in the range described above, so that excellent rigidity can be exhibited easily while maintaining a high flexural modulus.

incidentally, in the present application document, the proportion (F) of the oriented layer in the cross section of an injection molded product made of the polymer of olefins is measured by the method shown as follows.

### 1. Formation of Molded Product

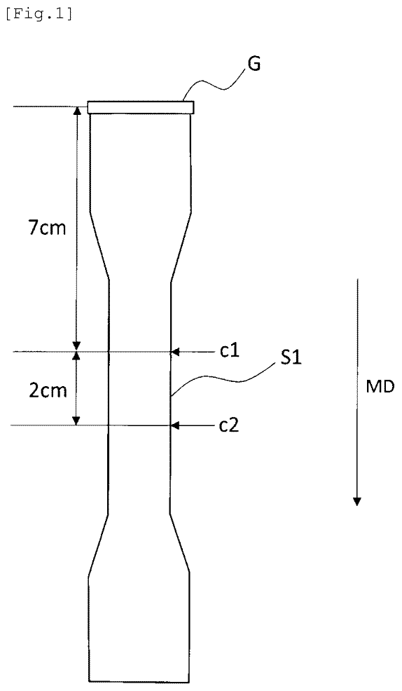

Through injection molding of a polymer of olefins under the following conditions according to JIS K 7152-1 and JIS K 6921-2, an injection molded product having a dumbbell-shaped external shape shown in FIG. 1 is obtained,

### (Injection Molding Conditions)

Equipment: NEX-III-3EG manufactured by Nissei Plastic Industrial Co., Ltd.
Type of test piece: Multi-purpose test piece type A1 described in JIS K 2139
Melting temperature of resin: 200° C.
Mold temperature: 40° C.
injection rate: 180 mm/s
Holding pressure: 50 MPa/40 seconds

### 2. Preparation of Measurement Sample (Slice for Polarizing Microscopic Observation)

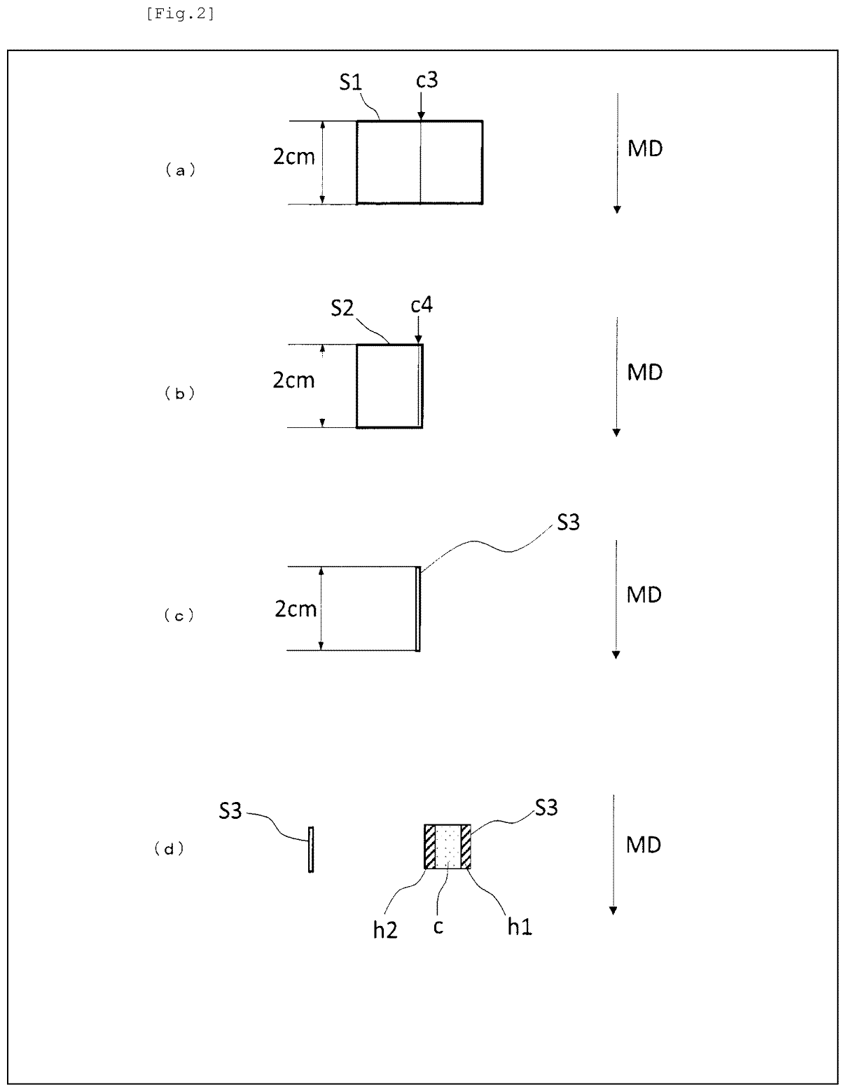

(1) As shown in FIG. 1, by cutting in the direction perpendicular to the resin traveling direction MD at a position c1 about 7 cm apart from a gate G in the resin traveling direction MD of the resulting molded product and further cutting in the direction perpendicular to the resin traveling direction MD at a position c2 about 2 cm apart from the position c1 in the resin traveling direction MD, a cut product 31 shown in FIG. 2(a) is obtained.

(2) As shown in FIG. 2(a), by cutting in parallel to the resin traveling direction MD at the center (position c3) of the cut product S1 obtained in (1), a cut product S2 shown in FIG. 2(b) is obtained.

(3) As shown in FIG. 2(b), using a rotary microtome device (RX-860 manufactured by Yamato Kohki Industrial Co., Ltd.), by cutting cut product S2 in the direction parallel to the resin traveling direction MD at a position c4 to a thickness of 30 μm, a measurement sample 3 in a slice shape shown in FIG. 2(c) is obtained.

(4) FIG. 2(d) is a schematic diagram showing the resulting measurement sample S3 in a slice shape. The diagram on the left side in FIG. 2(d) is the side view of measurement sample S3 in a slice shape corresponding to FIG. 2(c), and the diagram on the right side in FIG. 2(d) is a front view of the measurement sample S3 in a slice shape.

### 3. Polarizing Microscopic Observation

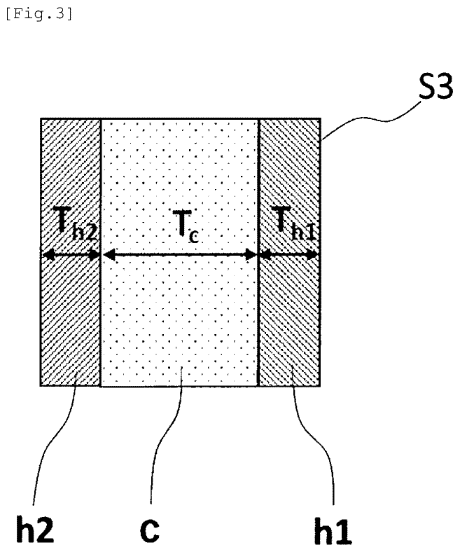

FIG. 3 is an enlarged front view of the measurement sample S3 in a slice shape shown on the right side in FIG. 2(d).

The measurement sample 53 is observed with a polarizing microscope device (EPCLIPSE LV-100NDA manufactured by NIKON Corporation) to identify a core layer c and an oriented layers h1 and h2. When the thickness of the core layer is expressed by Tc, and the thicknesses of the oriented layer are expressed by Th1 and Th2, the proportion F (%) of the oriented layer relative to the thickness of the molded layer is calculated using the following formula (β).

F(%)={(Th1+Th2)/(Th1+Tc+Th2)}×100 (β)

The thickness Tc of the core layer and the thicknesses Th1 and Th2 of the oriented layers are the arithmetic averages of the thicknesses of the core layer c and the thicknesses of the oriented layers h1 and h2 measured at three random spots of the measurement sample S3, respectively.

According to the present invention, a method for producing a polymer of olefins excellent in moldability with high melt flowability, and excellent rigidity with further higher flexural modulus.

### EXAMPLES

Next, the present invention is described in more detail with reference to Examples, though these are merely illustrative and do not limit the present invention.

### (Evaluation of Performance)

In Examples and Comparative Examples, evaluations of performance each were performed according to the following methods.

### <Content Ratio of Titanium Atoms>

The content ratio of titanium atoms was measured according to the method of JIS 8311-1997, using a solid catalyst component for polymerizing olefins with solvent components completely removed by heating and drying under reduced pressure in advance.

### <Content Ratio of Internal Electron-Donating Compound>

The content ratio of the internal electron-donating compounds (succinate diester compound and phthalate diester compound) was determined as follows. After hydrolyzing a solid catalyst component for polymerizing olefins with solvent components completely removed by heating and drying under reduced pressure in advance, the internal electron-donating compound was extracted using an aromatic solvent, and the solution was measured by gas chromatography (GC-14B, manufactured by Shimadzu Corporation) under the following conditions (gas chromatography FID method). Further, the number of moles of each component was determined from the measurement results of gas chromatography using a calibration curve measured at known concentrations in advance.

### [Measurement Conditions]

Column: packed column (ϕ 2.6×2.1 m, Silicone SE-30: 10%, Chromosorb WAW DMCS 80/100, manufactured by GL Sciences, Inc.)
Detector: FID (Flame Ionization Detector, hydrogen flame ionization-type detector)
Carrier gas: helium, flow rate: 40 mL/min
Measurement temperature: vaporization chamber: 280′C, column: 225′C, detector: 280° C.

### <Polymerization Activity>

The polymerization activity per gram of the solid catalyst component mixture was determined using the following formula (α).

Polymerization activity (g/g−cat)=Mass of polymer (g)/Mass of solid catalyst component mixture (g) (α)

### <Melt Flowability (MFR)>

The melt flow rate (MFP) (g/10 minutes), which indicates the melt flowability of a polymer, was measured according to ASTM D 1238 and JIS K 7210.

### <Flexural Modulus (FM)>

An injection molded test piece (thickness: 4.0 mm, width: 10.0 mm, length: 80 mm) prepared by using NEX30III3EG manufactured by Nissei Plastic industrial Co., Ltd., under conditions at a molding temperature of 200° C. and a mold temperature of 40° C. was subjected to measurement of flexural modulus (FM) of the polymer based on JIS K7171, under measurement atmosphere at 23° C.

### <Proportion (F) of Oriented Layer in Cross Section of Injection Molded Plate Made of Polymer>

### 1. Formation of Molded Product

By injection molding a polymer of olefins under the following conditions according to JIS K 7152-1 and JIS K 6921-2, an injection molded product having the dumbbell-shaped external form shown in FIG. 1 was obtained.

### [Injection Molding Conditions]

Equipment: NEX-III-3EG manufactured by Nissei Plastic Industrial Co., Ltd.
Type of test piece: multi-purpose test piece type A1 described in JIS K 7139
Melting temperature of resin: 200° C.
Mold temperature: 43° C.
Injection rate: 180 mm/s
Holding pressure: 50 MFa/40 seconds.

### 2. Preparation of Measurement Sample (Slice for Polarizing Microscopic Observation)

(1) As shown in FIG. 1, by cutting in the direction perpendicular to the resin traveling direction MD at a position c1 about 7 cm apart from a gate G in the resin traveling direction MD of the resulting molded product and further cutting in the direction perpendicular to the resin traveling direction MD at a position c2 about 2 cm apart from the position c1 in the resin traveling direction MD, a cut product S1 shown in FIG. 2(a) was obtained.

(2) As shown in FIG. 2(a), by cutting in parallel to the resin traveling direction MD at the center (position c3) of the cut product S1 obtained in (1), a cut product S2 shown in FIG. 2(b) was obtained.

(3) As shown in FIG. 2(b), using a rotary microtome device (RX-860 manufactured by Yamato Kohki Industrial Co., Ltd.), by cutting cut product S2 in the direction parallel to the resin traveling direction MD at a position c4 to a thickness of 30 μm, a measurement sample S3 in a slice shape shown in FIG. 2(c) was obtained.

(4) FIG. 2(d) is a schematic diagram showing the resulting measurement sample $3 in a slice shape. The diagram on the left side in FIG. 2(d) is the side view of measurement sample 53 in a slice shape corresponding to FIG. 2(c), and the diagram on the right side in FIG. 2(d) is a front view of the measurement sample S3 in a slice shape.

### 3. Polarizing Microscopic Observation

FIG. 3 is an enlarged front view of the measurement sample S3 in a slice shape shown on the right side in FIG. 2(d).

The measurement sample S3 was observed with a polarizing microscope device (EPCLIPSE LV-10NDA manufactured by NIKON Corporation) to identify a core layer c and an oriented layers h1 and h2. When the thickness of the core layer is expressed by Tc, and the thicknesses of the oriented layer are expressed by Th1 and Th2, the proportion F (%) of the oriented layer relative to the thickness of the molded layer was calculated using the following formula (β).

F(%)={(Th1+Th2)/(Th1+Tc+Th2)}×100 (β)

The thickness Tc of the core layer and the thicknesses Th1 and Th2 of the oriented layers are the arithmetic averages of the thicknesses of the core layer c and the thicknesses of the oriented layers h1 and h2 measured at three random spots of the measurement sample S3, respectively.

### Production Example 1

### <Synthesis of Solid Component>

Into a 500-mL round-bottom flask equipped with a stirrer, having internal atmosphere replaced with nitrogen gas, 25 mL of toluene and 20 mL of titanium tetrachloride were added, and 10 g of ethoxy magnesium and 30 mL of toluene were fed into a separately prepared 300-mL round-bottom flask to obtain a suspended state.

Next, the suspension was added to a 500-mL round-bottom flask in multiple batches, and after aging, the temperature was raised. When the temperature reached 60° C., 4.0 mL (3.9 g) of diethyl 2,3-diisopropyl succinate was added, and the temperature was further increased to 110° C.

Thereafter, the reaction was performed while stirring for 3 hours, with the temperature maintained at 110° C.

After completion of the reaction, washing with 80 mL of toluene at 100° C. was repeated four times, and then 15 mL of titanium tetrachloride and 45 mL of toluene were newly added. The temperature was raised to 100° C., and the reaction was performed while stirring for 15 minutes. Further, 15 mL of titanium tetrachloride and 45 mL of toluene were newly added thereto, and the temperature was raised to 100° C. The reaction while stirring for 15 minutes was performed twice. After completion of the reaction, washing with 75 mL of n-heptane at 60° C. was repeated six times, and then drying under reduced pressure was performed, so that a solid component (a1) in a powder state (first solid catalyst component for polymerizing olefins) was obtained.

In the resulting solid component (a1), the titanium content ratio was 3.4 mass % (0.071 mol %), and the content ratio of diethyl 2,3-diisopropyl succinate (succinate diester compound) was 18.7 mass % (0.072 mol %).

### Production Example 2

### <Synthesis of Solid Component>

Into a 500-mL round-bottom flask equipped with a stirrer, having internal atmosphere replaced with nitrogen gas, 40 mL of toluene and 20 mL of titanium tetrachloride were added. Into a separately prepared 300-mL round-bottom flask, 10 g of ethoxy magnesium and 45 mL of toluene were fed, and 2.6 mL of di-n-butyl phthalate (phthalate diester compound) was added to obtain a suspended state,

Next, the suspension was added to a 500-mL round-bottom flask in multiple batches, and after aging, the temperature was raised. When the temperature reached 60° C., 1.2 mL (1.3 q) of di-n-butyl phthalate was added, and the temperature was further increased to 110° C.

Thereafter, the reaction was performed while stirring for 2 hours, with the temperature maintained at 110° C.

After completion of the reaction, the supernatant liquid was removed. Washing with 100 ML of toluene was repeated four times, and then 20 mL of titanium tetrachloride and 80 ML of toluene were newly fed thereinto. The reaction was performed for 2 hours, while maintaining the liquid temperature at 105° C.

After completion of the reaction, washing with 100 mL of n-heptane was repeated eight times, drying under reduced pressure was performed, so that a solid component (b1) in a powder state (second solid catalyst component for polymerizing olefins) was obtained.

In the resulting solid component (b1), the titanium content ratio was 1.9 mass (0.040 mol %), and the content ratio of di-n-butyl phthalate (phthalate diester compound) was 10.5 mass % (0.040 mol %).

### Example 1

### <Preparation of Solid Catalyst Component Mixture>

A preparation container purged with nitrogen gas was prepared, and 2.0 mg of the solid component (a1) obtained in Production Example 1 and 5.9 mg of the solid component (b1) obtained in Production Example 2 were fed therein to obtain a solid catalyst component mixture (A1) (solid catalyst component mixture for polymerizing olefins).

In the resulting solid catalyst component mixture (A1), the content ratio of each component is shown in Table 1 and Table 2.

### <Formation of Polymerization Catalyst and Polymerization Reaction>

Into an autoclave with a stirrer having an internal volume of 2.0 liters purged with nitrogen gas, 1.32 mmol of triethyl aluminum, 0.26 mmol of dicyclopentyl bis(ethylamino)silane (T01) and 0.0038 mmol in terms of titanium atoms of the solid catalyst component mixture (A1) were fed to form a catalyst for polymerization.

Then, after 1.5 liters of hydrogen gas and 1.4 liters of liquefied propylene were fed to perform prepolymerization at 20° C. for 5 minutes, the temperature was raised to perform a polymerization reaction at 70° C. for 1 hour.

On this occasion, the polymerization activity of propylene (PP polymerization activity) per gram of solid catalyst component, the melt flowability (MFR) of the polymer, the flexural modulus (FM) of the polymer, and the proportion F (%) of the oriented layer in the cross-section of the injection molded plate made of the resulting polymer were measured. The results are shown in Table 3.

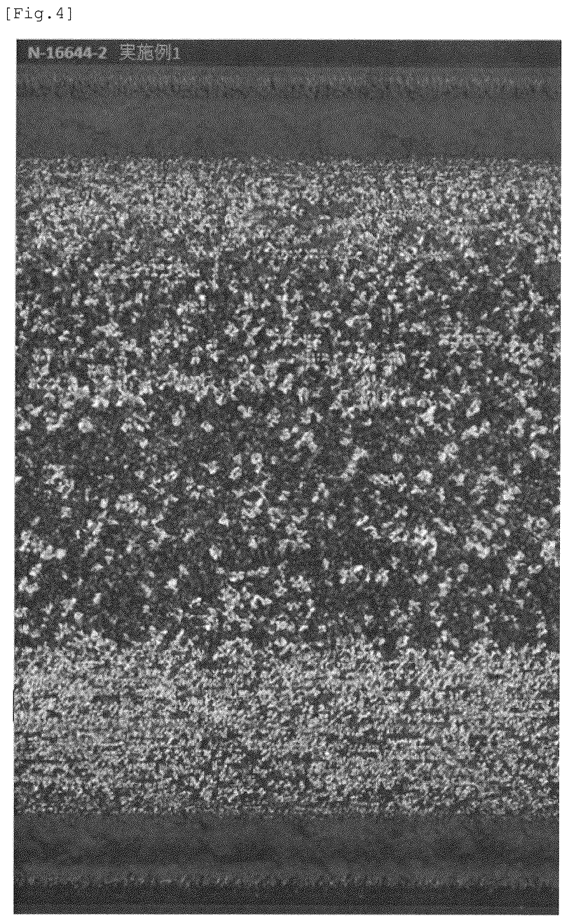

Further, a polarizing microscopic image of the measurement sample 3 in a slice shape used in measurement of the proportion F (%) of the oriented layer in the cross-section of the injection molded plate made of the resulting polymer is shown in FIG. 4.

### Example 2

### <Preparation of Solid Catalyst Component Mixture>

A preparation container purged with nitrogen gas was prepared, and 3.4 mg of the solid component (a1) obtained in Production Example 1 and 3.4 mg of the solid component (b1) obtained in Production Example 2 were fed therein to obtain a solid catalyst component mixture (A2) (solid catalyst component mixture for polymerizing olefins).

In the resulting solid catalyst component mixture (A2), the content ratio of each component is shown in Table 1 and Table 2.

### <Formation of Polymerization Catalyst and Polymerization Reaction>

Into an autoclave with a stirrer having an internal volume of 2.0 liters purged with nitrogen gas, 1.32 mmol of triethyl aluminum, 0.26 mmol of dicyclopentyl bis(ethylamino)silane (T01) and 0.0038 mmol in terms of titanium atoms of the solid catalyst component mixture (A2) were fed to form a catalyst for polymerization.

Then, after 1.5 liters of hydrogen gas and 1.4 liters of liquefied propylene were fed to perform prepolymerization at 20° C. for 5 minutes, the temperature was raised to perform a polymerization reaction at 70° C. for 1 hour.

On this occasion, the polymerization activity of propylene (PP polymerization activity) per gram of solid catalyst component, the melt flowability (MFR) of the polymer, the flexural modulus (FM) of the polymer, and the proportion F (%) of the oriented layer in the cross-section of the injection molded plate made of the resulting polymer were measured. The results are shown in Table 3.

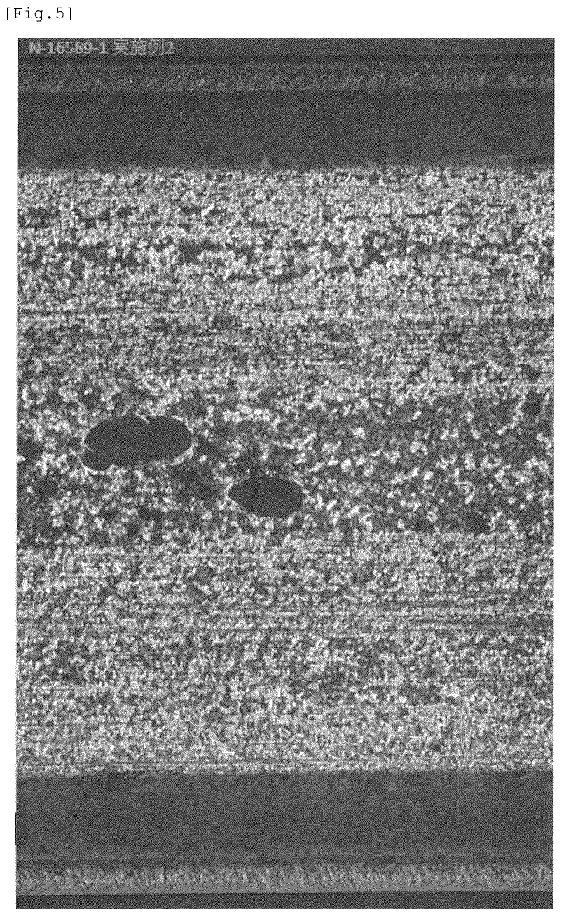

Further, a polarizing microscopic image of the measurement sample S3 in a slice shape used in measurement of the proportion F (%) of the oriented layer in the cross-section of the injection molded plate made of the resulting polymer is shown in FIG. 5.

### Example 3

### <Preparation of Solid Catalyst Component Mixture>

A preparation container purged with nitrogen gas was prepared, and 4.5 mg of the solid component (a1) obtained in Production Example 1 and 1.5 mg of the solid component (b1) obtained in Production Example 2 were fed therein to obtain a solid catalyst component mixture (A3) (solid catalyst component mixture for polymerizing olefins)

In the resulting solid catalyst component mixture (A3), the content ratio of each component is shown in Table 1 and Table 2.

### <Formation of Polymerization Catalyst and Polymerization Reaction>

Into an autoclave with a stirrer having an internal volume of 2.0 liters purged with nitrogen gas, 1.32 mmol of triethyl aluminum, 0.26 mmol of dicyclopentyl bis(ethylamino)silane (T01) and 0.0038 mmol in terms of titanium atoms of the solid catalyst component mixture (A3) were fed to form a catalyst for polymerization.

Then, after 1.5 liters of hydrogen gas and 1.4 liters of liquefied propylene were fed to perform prepolymerization at 20° C. for 5 minutes, the temperature was raised to perform a polymerization reaction at 70° C. for 1 hour.

On this occasion, the polymerization activity of propylene (PP polymerization activity) per gram of solid catalyst component, the melt flowability (MFR) of the polymer, the flexural modulus (FM) of the polymer, and the proportion F (%) of the oriented layer in the cross-section of the injection molded plate made of the resulting polymer were measured. The results are shown in Table 3.

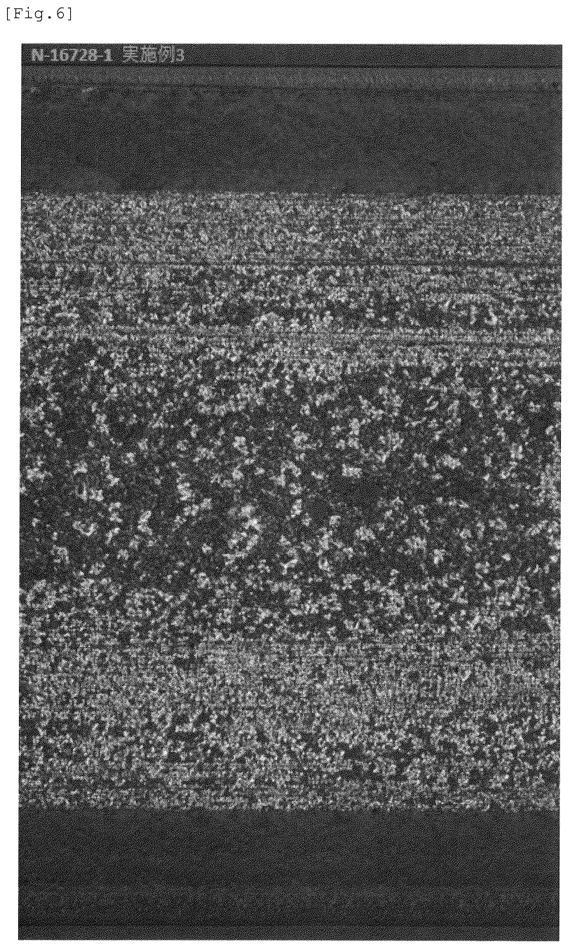

Further, a polarizing microscopic image of the measurement sample S3 in a slice shape used in measurement of the proportion F (M) of the oriented layer in the cross-section of the injection molded plate made of the resulting polymer is shown in FIG. 6.

### Comparative Example 1

in Comparative Example 1, the solid component (l) obtained in Production Example 1 (first solid catalyst component for polymerizing olefins) was used as solid catalyst component. (B) in formation of the polymerization catalyst and the polymerization reaction described below.

The content ratio of each component in the solid catalyst component (S1) is shown in Table 1 and Table 2.

### <Formation of Polymerization Catalyst and Polymerization Reaction>

Into an autoclave with a stirrer having an internal volume of 2.0 liters purged with nitrogen gas, 1.32 mmol of triethyl aluminum, 0.26 mmol of dicyclopentyl bis(ethylamino)silane (T01) and 0.0038 mmol in terms of titanium atoms of the solid catalyst component mixture (B1) were fed to form a catalyst for polymerization.

Then, after 1.5 liters of hydrogen gas and 1.4 liters of liquefied propylene were fed to perform prepolymerization at 20° C. for 5 minutes, the temperature was raised to perform a polymerization reaction at 70° C. for 1 hour.

On this occasion, the polymerization activity of propylene (PF polymerization activity) per gram of solid catalyst component, the melt flowability (MFR) of the polymer, the flexural modulus (FM) of the polymer, and the proportion F (1) of the oriented layer in the cross-section of the injection molded plate made of the resulting polymer were measured. The results are shown in Table 3.

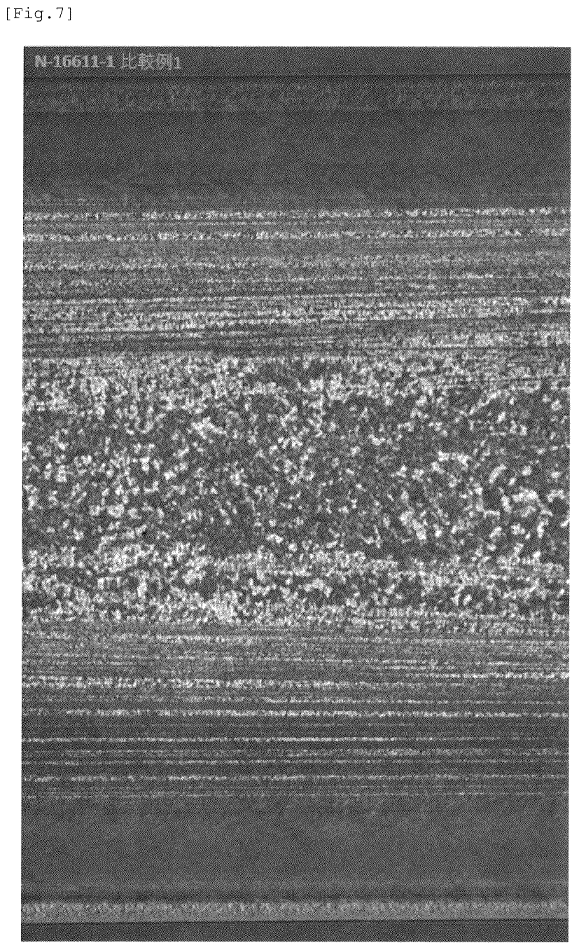

Further, a polarizing microscopic image of the measurement sample S3 in a slice shape used in measurement of the proportion F (M) of the oriented layer in the cross-section of the injection molded plate made of the resulting polymer is shown in FIG. 7.

### Comparative Example 2

In Comparative Example 2, the solid component (b1) obtained in Production Example 2 (second solid catalyst component for polymerizing olefins) was used as solid catalyst component (B2) in formation of the polymerization catalyst and the polymerization reaction described below.

The content ratio of each component in the solid catalyst component (82) is shown in Table 1 and Table 2.

### <Formation of Polymerization Catalyst and Polymerization Reaction>

Into an autoclave with a stirrer having an internal volume of 2.0 liters purged with nitrogen gas, 1.32 mmol of triethyl aluminum, 0.26 mmol of dicyclopentyl bis(ethylamino)silane (T01) and 0.0024 mmol in terms of titanium atoms of the solid catalyst component mixture (B2) were fed to form a catalyst for polymerization.

Then, after 1.5 liters of hydrogen gas and 1.4 liters of liquefied propylene were fed to perform prepolymerization at 20° C. for 5 minutes, the temperature was raised to perform a polymerization reaction at 70° C. for 1 hour.

On this occasion, the polymerization activity of propylene (PP polymerization activity) per gram of solid catalyst component, the melt flowability (MFR) of the polymer, the flexural modulus (FM) of the polymer, and the proportion F (%) of the oriented layer in the cross-section of the injection molded plate made of the resulting polymer were measured. The results are shown in Table 3.

Further, a polarizing microscopic image of the measurement sample A3 in a slice shape used in measurement of the proportion F (%) of the oriented layer in the cross-section of the injection molded plate made of the resulting polymer is shown in Figure B.

### Comparative Example 2

### <Preparation of Solid Catalyst Component Mixture>

A preparation container purged with nitrogen gas was prepared, and 4.7 mg of the solid component. (a1) obtained in Production Example 1 and 1.2 mg of the solid component (b1) obtained in Production Example 2 were fed therein to obtain solid catalyst component mixture (A3) (solid catalyst component mixture for polymerizing olefins).

In the resulting solid catalyst component mixture (B3), the content ratio of each component is shown in Table 1 and Table 2.

### <Formation of Polymerization Catalyst and Polymerization Reaction>

Into an autoclave with a stirrer having an internal volume of 2.0 liters purged with nitrogen gas, 1.32 mmol of triethyl aluminum, 0.26 mmol of dicyclopentyl bis(ethylamino)silane (T01) and 0.0038 mmol in terms of titanium atoms of the solid catalyst component mixture (B3) were fed to form a catalyst for polymerization.

Then, after 1.5 liters of hydrogen gas and 1.4 liters of liquefied propylene were fed to perform prepolymerization at 20° C. for 5 minutes, the temperature was raised to perform a polymerization reaction at 70° C. for 1 hour.

On this occasion, the polymerization activity of propylene (PP polymerization activity) per gram of solid catalyst component, the melt flowability (MFR) of the polymer, the flexural modulus (FM) of the polymer, and the proportion F (%) of the oriented layer in the cross-section of the injection molded plate made of the resulting polymer were measured. The results are shown in Table 3.

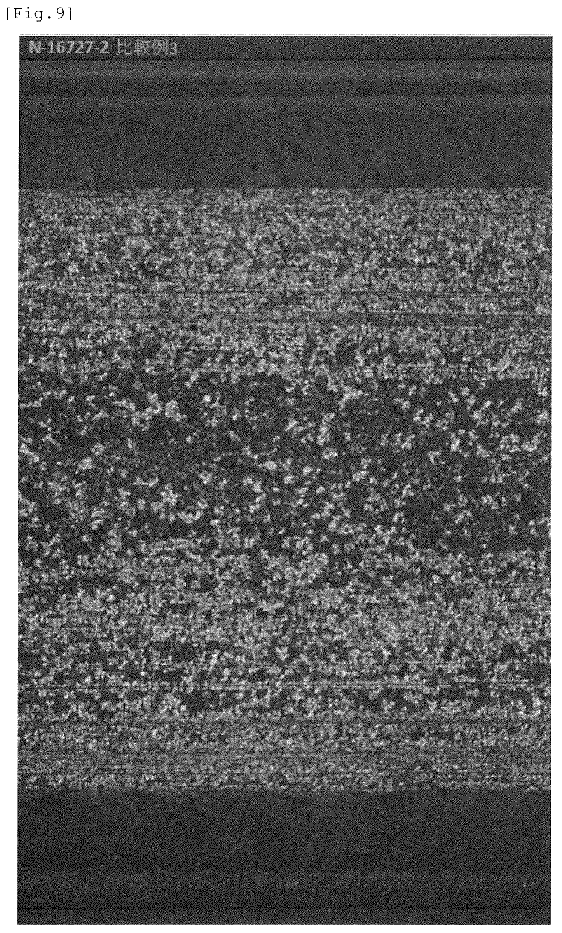

Further, a polarizing microscopic image of the measurement sample 53 in a slice shape used in measurement of the proportion F (%) of the oriented layer in the cross-section of the injection molded plate made of the resulting polymer is shown in FIG. 9.

### Comparative Example 4

### <Preparation of Solid Catalyst Component Mixture>

A preparation container purged with nitrogen gas was prepared, and 1.6 mg of the solid component (a1) obtained in Production Example 1 and 6.5 mg of the solid component (b1) obtained in Production Example 2 were fed therein to obtain solid catalyst component mixture (B4) (solid catalyst component mixture for polymerizing olefins).

In the resulting solid catalyst component mixture (B4), the content ratio of each component is shown in Table 1 and Table 2.

### <Formation of Polymerization Catalyst and Polymerization Reaction>

Into an autoclave with a stirrer having an internal volume of 2.0 liters purged with nitrogen gas, 1.32 mmol of triethyl aluminum, 0.26 mmol of dicyclopentyl bis(ethylamino)silane (T01) and 0.0038 mmol in terms of titanium atoms of the solid catalyst component mixture (B4) were fed to form a catalyst for polymerization.

Then, after 1.5 liters of hydrogen gas and 1.4 liters of liquefied propylene were fed to perform prepolymerization at 20° C. for 5 minutes, the temperature was raised to perform a polymerization reaction at 70° C. for 1 hour.

On this occasion, the polymerization activity of propylene (PP polymerization activity) per gram of solid catalyst component, the melt flowability (MFR) of the polymer, the flexural modulus (FM) of the polymer, and the proportion of the oriented layer in the cross-section of the injection molded plate made of the resulting polymer were measured. The results are shown in Table 3.

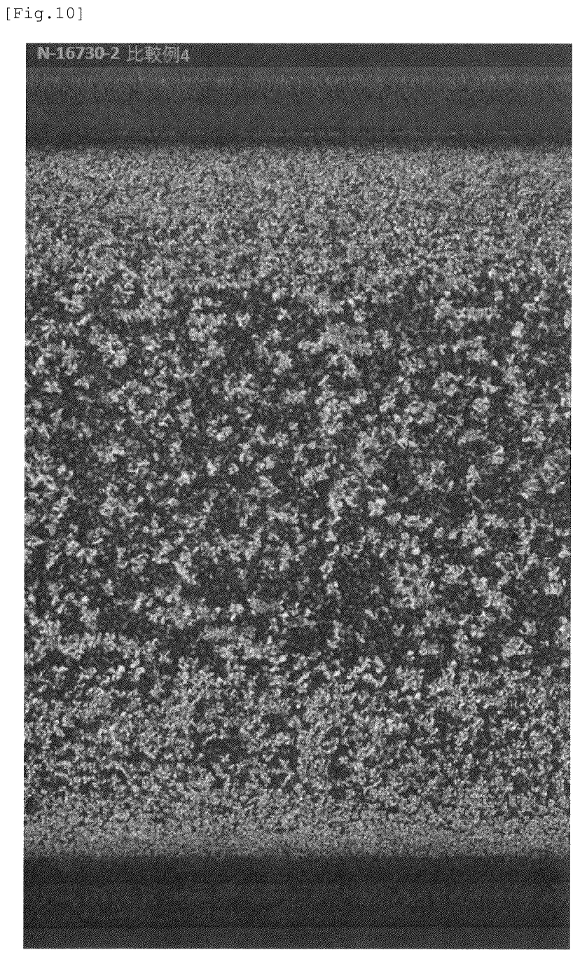

Further, a polarizing microscopic image of the measurement sample S3 in a slice shape used in measurement of the proportion F (%) of the oriented layer in the cross-section of the injection molded plate made of the resulting polymer is shown in FIG. 10.

TABLE 1

| | Content ratio of each component in solid | | | |
|---|---|---|---|---|
| | catalyst component mixture (based on mass) | | | |
| | | Succinate | Phthalate | Succinate diester |
| | Titanium | diester | diester | compound/Phthalate |
| | atom | compound | compound | diester compound |
| | (mass %) | (mass %) | (mass %) | (molar ratio) |
| Example 1 | 2.3 | 4.7 | 7.9 | 37:63 |
| Example 2 | 2.7 | 9.4 | 5.3 | 64:36 |
| Example 3 | 3.0 | 14.0 | 2.6 | 84:16 |
| Comparative | 3.4 | 18.7 | 0.0 | 100:0 |
| Example 1 | | | | |
| Comparative | 1.9 | 0.0 | 10.5 | 0:100 |
| Example 2 | | | | |
| Comparative | 3.1 | 15.0 | 2.1 | 88:12 |
| Example 3 | | | | |
| Comparative | 2.2 | 3.7 | 8.4 | 31:69 |
| Example 4 | | | | |

TABLE 2

| | Content ratio of each component in solid | | | |
|---|---|---|---|---|
| | catalyst component mixture (based on mol) | | | |
| | | Succinate | Phthalate | Succinate diester |
| | Titanium | diester | diester | compound/Phthalate |
| | atom | compound | compound | diester compound |
| | (mol %) | (mol %) | (mol %) | (molar ratio) |
| Example 1 | 0.048 | 0.018 | 0.030 | 37:63 |
| Example 2 | 0.055 | 0.036 | 0.020 | 64:36 |
| Example 3 | 0.063 | 0.054 | 0.010 | 84:16 |
| Comparative | 0.071 | 0.072 | 0.000 | 100:0 |
| Example 1 | | | | |
| Comparative | 0.040 | 0.000 | 0.040 | 0:100 |
| Example 2 | | | | |
| Comparative | 0.065 | 0.058 | 0.008 | 88:12 |
| Example 3 | | | | |
| Comparative | 0.046 | 0.014 | 0.032 | 31:69 |
| Example 4 | | | | |

TABLE 3

| | Evaluation of polymerization properties | | | |
|---|---|---|---|---|
| | Polymerization | MFR | | Proportion of |
| | activity | (g/10 | FM | oriented |
| | (g/g Cat) | minutes) | (MPa) | layer F (%) |
| Example 1 | 46,000 | 120 | 1,900 | 20.6 |
| Example 2 | 44,200 | 99 | 2,180 | 27.5 |
| Example 3 | 43,000 | 90 | 2,200 | 27.8 |
| Comparative | 45,200 | 56 | 2,270 | 28.4 |
| Example 1 | | | | |
| Comparative | 52,800 | 150 | 1,720 | 9.1 |
| Example 2 | | | | |
| Comparative | 45,600 | 78 | 2,240 | 28.1 |
| Example 3 | | | | |
| Comparative | 49,000 | 140 | 1,780 | 15.3 |
| Example 4 | | | | |

From Table 1 and Table 3, it has been found that in Examples 1 to 3, a polymer of olefins having excellent moldability having a high melt flowability (MFR) of 80 to 120 g/10 minutes and excellent rigidity with a high flexural modulus (FM) of 1900 MPa or more can be produced easily by preparing a solid catalyst component mixture for polymerizing olefins comprising a first solid catalyst component for polymerizing olefins containing magnesium, titanium, halogen and a succinate diester compound and a secondi solid catalyst component for polymerizing olefins containing magnesium, titanium, halogen and a phthalate diester compound at a mass ratio of First solid catalyst component for polymerizing olefins:Second solid catalyst component for polymerizing olefins=37:63 to 87:13, and using the solid catalyst component mixture for polymerization of olefins.

The reason is presumed that by using a mixture containing the first solid catalyst component for polymerizing olefins and the second solid catalyst component for polymerizing olefins each at a predetermined ratio in polymerization of olefins, a first polymer of olefins having a high flexural modulus and a broad molecular weight distribution is formed with the first solid catalyst component for polymerizing olefins, and the first polymer of olefins having a broad molecular weight distribution has a high compatibility with the second polymer of olefins formed with the second solid catalyst component for polymerizing olefins. In fact, as shown in FIG. 4 to FIG. 6 and the proportion of oriented layer F in Table 3, it has been found that when olefins were polymerized using the solid catalyst component mixture for polymerizing olefins obtained in Examples 1 to 3, the resulting polymer of olefins can exhibit high melt flowability without great change in the proportion of the oriented layers (Th1 and Th2) that affects the flexural modulus.

On the other hand, from Table 1 and Table 3, it has been found that in Comparative Example 1 and Comparative Example 2, since only any one of a solid catalyst component for polymerizing olefins containing magnesium, titanium, a halogen and a succinate diester compound and a solid catalyst component for polymerizing olefins containing magnesium, titanium, a halogen and a phthalate diester compound is used, only a polymer of olefins having poor moldability with a low melt flowability MFR of 56 g/10 minutes (Comparative Example 1) or a polymer of olefins having poor rigidity with a low flexural modulus (FM) of 1120 MPa (Comparative Example 2) was obtained, when used for polymerization of olefins.

Further, from Table 1 and Table 3, it has been found that in Comparative Example 3 and Comparative Example 4, since solid catalyst component mixtures for polymerizing olefins having a mixing ratio between the first solid catalyst component for polymerizing olefins and the second solid catalyst component for polymerizing olefins out of a predetermined range were prepared for use in polymerizing olefins, only a polymer of olefins having poor moldability with a low melt flowability MFR of 78 g/10 minutes (Comparative Example 3) or a polymer of olefins having poor rigidity with a low flexural modulus (FM) of 1780 MPa (Comparative Example 4) was obtained when used for polymerization of olefins.

### INDUSTRIAL APPLICABILITY

According to the present invention, a solid catalyst component mixture for polymerizing olefins that allows a polymer of olefins having both a high melt flowability and rigidity to be easily produced is provided together with production methods of a catalyst for polymerizing olefins and a polymer of olefins.

1. A solid catalyst component mixture for polymerizing olefins comprising:
a first solid catalyst component for polymerizing olefins containing magnesium, titanium, halogen and a succinate diester compound and
a second solid catalyst component for polymerizing olefins containing magnesium, titanium, halogen and a phthalate diester compound
at a mass ratio of First solid catalyst component for polymerizing olefins:Second solid catalyst component for polymerizing olefins=37:63 to 87:13.

2. The solid catalyst component mixture for polymerizing olefins according to claim 1, wherein the content ratio of the succinate diester compound in terms of solid content is 4.7 to 14.9 mass %.

3. The solid catalyst component mixture for polymerizing olefins according to claim 1, wherein the content ratio of the phthalate diester compound in terms of solid content is 2.2 to 7.9 mass %.

4. A catalyst for polymerizing olefins comprising:
(I) the solid catalyst component mixture for polymerizing olefins according to claim 1, and
(II) one or more organic aluminum compounds selected from the compounds represented by the following general formula (1): 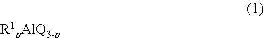
wherein R¹ is an alkyl group having 1 to 6 carbon atoms, Q is a hydrogen atom or a halogen atom, p satisfies 0<p≤3, and when a plurality of R¹ is present, R¹ may be the same or different from each other, and when a plurality of Q is present, Q may be the same or different from each other.

5. The catalyst for polymerizing olefins according to claim 4 comprising:
(I) the solid catalyst component mixture for polymerizing olefins,
(II) one or more organic aluminum compounds selected from the compounds represented by the following general formula (1): 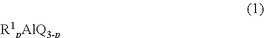
wherein R¹ is an alkyl group having 1 to 6 carbon atoms, Q is a hydrogen atom or a halogen atom, p satisfies 0<p≤3, and when a plurality of R¹ is present, R¹ may be the same or different from each other, and when a plurality of Q is present, Q may be the same or different from each other, and
(III) an external electron-donating compound.

6. A method for producing polymer of olefins comprising polymerizing olefins using the catalyst for polymerizing olefins according to claim 4.

7. A method for producing polymer of olefins comprising polymerizing olefins using the catalyst for polymerizing olefins according to claim 5.
